(19) United States
(12) Patent Application Publication
(10) Pub. No.: US 2024/0249428 A1
(43) Pub. Date: Jul. 25, 2024

(54) System and Method for Virtual Verification in Pharmacy Workflow

(71) Applicant: CVS Pharmacy, Inc., Woonsocket, RI (US)

(72) Inventors: Alan Bachmann, Cranberry Township, PA (US); Rik Banerjee, Attleboro, MA (US); Ajay K. Behuria, Upton, MA (US); David Fafel, Nashua, NH (US); Shreesha Jayaseetharam, Rolling Meadows, IL (US); Vanteya A. Pandit, North Attleboro, MA (US); Grant Peret, Bedford, NH (US); Kyle Robertson, Manchester, NH (US); Patrick D. Ruff, Pascoag, RI (US); Hari Charan Vemula, The Colony, TX (US)

(21) Appl. No.: 18/623,783

(22) Filed: Apr. 1, 2024

Related U.S. Application Data
(63) Continuation-in-part of application No. 17/330,803, filed on May 26, 2021.
(63) Continuation-in-part of application No. 17/330,813, filed on May 26, 2021.
(60) Provisional application No. 63/032,328, filed on May 29, 2020.

(51) Int. Cl. G06T 7/70; A61J 7/02; G06V 10/82; G06V 30/224

(52) U.S. Cl. CPC G06T 7/70; A61J 7/02; G06V 10/82; G06V 30/224; G06T 2207/20081; G06T 2207/20084; G06T 2207/30242

(57) ABSTRACT

A method and system provide for automated detection of prescription product conditions and enables virtual verification of the dispensed prescription product. The method and system include receiving an image of a prescription product to be dispensed according to a prescription to a patient, processing the image with an artificial intelligence model to generate a condition signal indicating a prescription product condition, sending the condition signal to an image analysis engine; and responsive to receiving the condition signal, performing an action based on the prescription product condition.

### CROSS-REFERENCE TO RELATED APPLICATION(S)

This application is a continuation-in-part of U.S. Non-Provisional App. No. 17/330,803, filed May 26, 2021, entitled “System and Method for Imaging Pharmacy Workflow in a Virtual Verification System,” which is incorporated herein by reference in its entirety, and of U.S. Non-Provisional application Ser. No. 17/330,813, filed May 26, 2021, entitled “System and Method for Virtual Verification in Pharmacy Workflow,” which is incorporated herein by reference in its entirety, and that claims the benefit of and priority to U.S. Provisional App. No. 63/032,328, filed May 29, 2020, which is incorporated herein by reference in its entirety.

### FIELD OF THE INVENTION

The present disclosure relates to the filling and verification of prescriptions by a pharmacy. In particular, the present disclosure relates to virtual verification that a prescription has been filled correctly.

### BACKGROUND OF THE DISCLOSURE

In today's pharmacy workflow, a number of steps require physical handling of the prescription product which is time consuming. For instance, a considerable amount of time is spent by pharmacy staff performing product verification in a prescription fulfillment workflow. The process of product verification may include the pharmacist having to open a vial, pour out the contents of the vial onto a tray, manually inspect and compare the contents against a stock image of a prescription product, pour contents back into the vial, close vial, place the vial in a bag, and so on.

### SUMMARY

This disclosure relates to a method and a system for identifying prescription product conditions using artificial intelligence and generating a warning signal or taking corrective action. Further, the method and system provide for automated counting of prescription product and enables virtual verification of the dispensed prescription product.

According to one aspect of the subject matter described in this disclosure, a method includes receiving an image of a prescription product to be dispensed according to a prescription to a patient; processing the image with an artificial intelligence model to generate a condition signal indicating a prescription product condition; sending the condition signal to an image analysis engine; and responsive to receiving the condition signal, performing an action based on the prescription product condition.

In general, another aspect of the subject matter described in this disclosure includes a system comprising one or more processors and memory operably coupled with the one or more processors, wherein the memory stores instructions that, in response to the execution of the instructions by one or more processors, cause the one or more processors to perform the operations of receiving an image of a prescription product to be dispensed according to a prescription to a patient; processing the image with an artificial intelligence model to generate a condition signal indicating a prescription product condition; sending the condition signal to an image analysis engine; and responsive to receiving the condition signal, performing an action based on the prescription product condition.

Other implementations of one or more of these aspects include corresponding systems, apparatus, and computer programs, configured to perform the actions of the methods, encoded on computer storage devices.

These and other implementations may each optionally include one or more of the following features, or any combination thereof. For instance, wherein the image includes a pill counting tray, and the prescription product is one or more pills, or wherein the prescription product condition is a number of pills in the image, and the condition signal includes a numerical value of a pill count. For instance, the prescription product condition is one from the group of: image quality, image brightness, image blur, image focus, number of pills, types of pills in the image, co-mingling of 2 different pill types in the image, a broken pill, pill residue, non-pill object presence, strip presence, pill bottle presence, stacked pills, watermark, tamper condition, pill cut, and therapeutic classification. In another instance, the artificial intelligence model is one from the group of: a neural network, a convolutional neural network, a random forest algorithm, a classifier, a You Only Look Once model, geometric systems like nearest neighbors and support vector machines, probabilistic systems, evolutionary systems like genetic algorithms, decision trees, Bayesian inference, boosting, logistic regression, faceted navigation, query refinement, query expansion, singular value decomposition, and a Markov chain. For example, the method may also include processing the image with a first artificial intelligence model to generate a first condition signal indicating a first prescription product condition, processing the image with a second artificial intelligence model to generate a second condition signal indicating a second prescription product condition, and generating the prescription product condition based on a combination of the first prescription product condition and the second prescription product condition, and wherein the first prescription product condition is different than the second prescription product condition. In another example, the method may further include generating an image annotation by retrieving the image, determining a portion of the received image to annotate, generating an annotation based upon the prescription product condition, combining the annotation with the received image to produce an annotated image, and providing the annotated image for presentation to the user. For instance, the method may also include performing optical character recognition on the image to generate recognized text, sending the recognized text to the image analysis engine, and wherein the action is determined in part based upon the recognized text. In another example, the method also includes generating retraining annotations by performing inference on the artificial intelligence model, generating labels from the retraining annotations, generating a training set of images and labels, process one or more images in the training set of images to correct one or more mislabeled items and generate corrected data and weights, retraining the artificial intelligence model using the corrected data and weights to produce a retrained artificial intelligence model, and using the retrained artificial intelligence model for the artificial intelligence model. In yet another instance, the action is one from the group of: generating and sending a warning signal, generating and sending a warning signal including the prescription product condition, generating and sending a signal including a number of pills detected in the image, generating an indication that the image of a prescription product is unacceptable and sending a signal to prompt capture another image to replace the image, generating annotated image and presenting the annotated image for display, generating an indication that the image of a prescription product is unacceptable and automatically recapture another image to replace the image, storing a copy of the image; and any one or more of the above actions.

All examples and features mentioned above can be combined in any technically possible way.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 shows an example workflow for verifying a prescription product during a prescription fill process.

FIG. 2 shows a comparison between a prior pharmacy workflow and a pharmacy workflow including the virtual verification described herein.

FIG. 3 shows an example of a bifurcated workflow between a supervising pharmacy and a remote dispensing site for verifying a prescription product during a prescription fill process.

FIG. 4 shows an example implementation of system for image analysis and virtual verification of prescription product used in a pharmacy workflow.

FIG. 5 shows an example implementation of a counting and imaging tray in accordance with the present disclosure.

FIG. 6 shows a top view, a perspective view, a front view, and a left side view of the example implementation of a counting and imaging tray.

FIG. 7 shows an example imaging device with a dual camera configuration in accordance with the present disclosure.

FIG. 8 shows an example imaging device with a single camera configuration in accordance with the present disclosure.

FIG. 9A shows an example high level architecture diagram depicting an interaction between a dispensing application and an image analysis engine for implementing virtual verification.

FIG. 9B shows an example of processing of an image for virtual verification at a remote site.

FIG. 10 is a flowchart showing one implementation for a process implemented by the prescription validator for counting an amount of the prescription product in an image and returning a confidence interval associated with a count.

FIG. 11 shows a graphical representation of an example output obtained from analyzing an image of pills using K-nearest neighbors or K-means clustering.

FIG. 12A shows a graphical representation of an example output obtained from analyzing an image of pills using image segmentation or templating.

FIG. 12B shows a graphical representation of sample captured images with various identified warning conditions.

FIG. 12C shows a graphical representation of sample captured images from which electronically generated quantity of pill counts may be generated.

FIG. 12D shows a graphical representation of sample captured images from which a broken pill may be detected.

FIG. 12E shows a graphical representation of sample captured images of a verification tray from which co-mingled pills may be detected.

FIG. 12F shows a graphical representation of a sample captured image of a verification tray from which strips or text may be detected.

FIG. 12G shows a graphical representation of a sample captured image of a verification tray upon which an enhanced therapeutic classification check may be performed.

FIG. 12H shows a graphical representation of a sample captured image from a pill container with a portion of the image enhanced.

FIG. 12I shows a graphical representation of a sample captured image of a pill vial on the verification tray.

FIG. 12J shows a graphical representation of a sample captured image of a pack on the verification tray.

FIG. 12K shows a graphical representation of a sample captured image of a prescription medication box on the verification tray.

FIG. 12L shows a graphical representation of sample captured images of stock bottles on the verification tray.

FIG. 12M shows a graphical representation of a sample captured image of a medication pen on the verification tray.

FIG. 12N shows a graphical representation of sample captured images showing pill residue conditions on the verification tray.

FIGS. 12O and 12P show a graphical representation of sample captured images showing other items detectable on the verification tray.

FIGS. 13A-13E are graphical representations of example user interfaces generated by a dispensing application in accordance with the present disclosure.

FIG. 14 is a graphical representation of an example user interface for visual verification of the prescription product.

FIG. 15 is a block diagram of an example pharmacy computing device and servers hosting enterprise pharmacy data systems and/or the image analysis engine.

FIG. 16 is a flowchart of configuring a system for facilitating virtual verification of dispensed prescription product.

FIG. 17 is a flowchart for a method for virtual verification of dispensed prescription product.

FIG. 18 shows an example high level architecture diagram depicting an AI image analysis engine according to a first implementation.

FIG. 19 shows an example high level architecture diagram depicting the AI data sets, models and training of the image analysis engine according to a second implementation.

FIG. 20 shows an example AI processing flow of images in accordance with some implementations of the present disclosure.

FIG. 21 is a flowchart for a method for virtual verification of dispensed prescription product that uses artificial intelligence.

FIG. 22 is a flowchart for a method for automated retraining the artificial intelligence model of an image analysis engine.

### DETAILED DESCRIPTION

With the advent of artificial intelligence and computer vision, there is an opportunity to virtualize, speed up, and improve the accuracy by which product verification is performed in the pharmacy workflow. An improved verification process in the pharmacy workflow, as described herein, eliminates physical handling of a prescription product by a pharmacist and saves time in the pharmacy workflow. An imaging device may be installed at a site, such as a retail pharmacy, to enable virtual verification. The imaging device captures high quality images of a prescription product, such as pills, tablets, capsules, caplets, liquid bottles, canisters, etc. for a pharmacist (e.g., situated remotely) to virtually verify the prescription product before it is dispensed to a customer at a point of sale. A dispensing application may be installed on one or more pharmacy computing devices in a pharmacy, such as a laptop, tablet, etc., to operate in conjunction with the imaging device to scan, capture, and store data including one or more images of the prescription product.

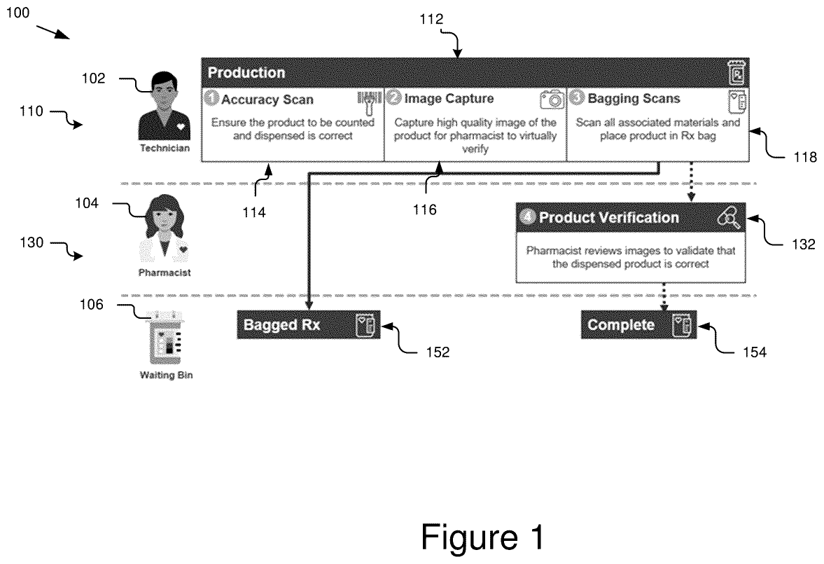

FIG. 1 shows an example workflow 100 for verifying a prescription product during a prescription fill process. A pharmacy or similar workspace may include multiple workstations for processing and fulfilling drug prescriptions wherein one or more workstations perform one or more stages involved in processing prescriptions. Each workstation is designated, and, optionally, is configured, to accomplish one or more tasks. Workstation tasks can be defined in terms of the roles and responsibilities, as well as the skill levels required, of persons who staff each workstation. In addition, definition of workstation tasks can be directed to limiting staff to a single or primary pharmacy customer interface of a workstation to ensure effective customer communication and efficient workflow.

The designated workstations and defined tasks help to create a stage-by-stage process or a compartmentalized workflow whereby each processing stage is handled and/or completed at one or more workstations by one or more staff persons having the requisite skill level, e.g., registered pharmacist (RPh), certified or otherwise trained technician (CT), a customer support associate (CSA) or other support person. In addition, the workstations and tasks are defined to help to permit early detection and resolution of issues or problems that can occur during processing. Further, the defined workstations and tasks help to distribute the process of prescription fulfillment efficiently among one or more staff persons and help a pharmacy to provide customers with relatively accurate prescription pick-up times that meet customers' needs and expectations.

In part, the system queues and interfaces described herein may guide a technician 102 through the prescription production 112 including 1) scanning 114 the prescription product for accuracy and preparing or filling the prescription order, 2) capturing 116 high quality images of the prescription product, and 3) scanning 118 all materials associated with the prescription product, bagging 152 and placing the prescription product in a waiting bin 106. The registered pharmacist 104 may then be guided through additional system queues and interfaces at their workstation to 4) virtually review the captured images to verify and validate 132 that the dispensed product is correct and complete 154 before it is handed to the customer at the point of sale. Virtual verification of the prescription product, which may be performed at a second site 130, eliminates redundant physical handling of the prescription product by a pharmacist and enables the technician to perform the bulk of the production at a first site 110 including bagging the prescription product for pick up. It should be noted that the first and second sites may be different workspaces collocated within a single pharmacy, or the first and second sites may be physically remote from one another.

Some of the eliminated redundant physical tasks of a pharmacist may include but are not limited to:
1—Retrieving basket,
2—Removing label and product from the basket,
3—Scanning label,
4—Scanning product label,
5—Opening vial,
6—Pouring contents into verification tray,
7—Pouring contents back into the vial,
8—Closing the vial,
9—Retrieve empty prescription bag,
10—Placing contents into the prescription bag,
11—Affixing label to the prescription bag,
12—Stapling the label to the prescription bag, and
13—Placing the prescription bag in the holding area.

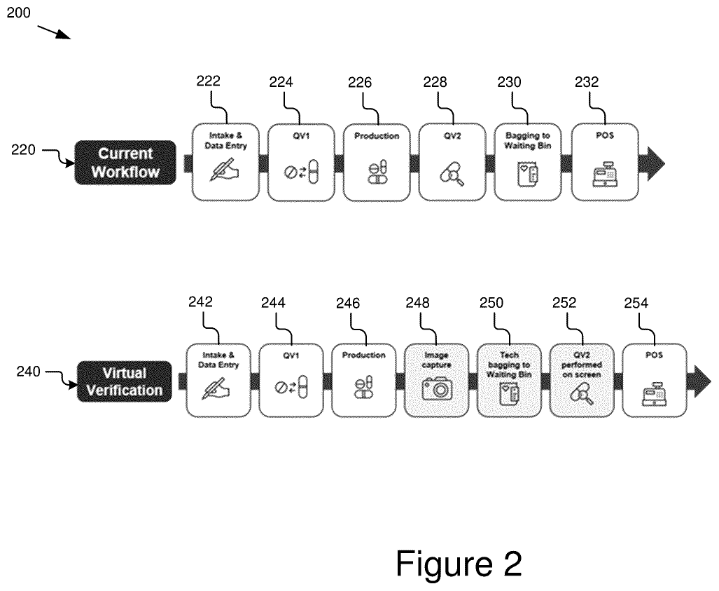

FIG. 2 shows a comparison 200 between a current or conventional pharmacy workflow 220, and an improved pharmacy workflow 240 including the virtual verification. For example, in a current or conventional pharmacy workflow 220, a technician inputs 222 a prescription into a workflow system. In a first quality verification (QV1), the technician verifies in step 224 the bulk prescription product corresponds to the prescription product identified in the prescription. The technician then engages in production 226 by counting and filling the vial according to the prescription. In a second quality verification (QV2), a pharmacist subsequently verifies in step 228 the results of the production by the technician by manually recounting and re-verifying the prescription product in the vial. The pharmacist bags and places 230 the filled prescription product in a waiting bin in preparation for a patient to purchase 232 the prescription product at a point-of-sale location. As noted, the prescription product is handled in step 224 and re-handled in step 228. A re-handling of the product injects delay and subjects the prescription product to compromise and errors in the workflow process.

For example, one implementation of the improved pharmacy workflow 240 shown in FIG. 2, eliminates the second or subsequent re-handling of the prescription product. The technician as part of his or her workflow fills the prescription as per order (production), places the prescription product in an imaging device, captures one or more images of the prescription product, scans a barcode on the prescription product, bags and places the prescription product in a waiting bin. In a second implementation of the improved pharmacy workflow 240, the technician then scans product for accuracy at dispensing system, places the product on imaging device, captures pictures, labels, and scans product labels, places the prescription into a bag, and transfers to waiting bin/will-call area.

Specifically, a technician inputs 242 a prescription into a workflow system. In a first quality verification (QV1), the technician verifies in step 244 the bulk prescription product corresponds to the prescription product identified in the prescription. The technician then engages in production in step 246 by counting the prescription product according to the prescription. A camera at a first site, the technician site, captures in step 248 an image of the prescription product to be dispensed according to the prescription of the patient. The technician then packages in step 250 the prescription product for sale at the site of the technician prior to receiving a verification from a pharmacist. The packaged prescription product may then be sealed and placed in a waiting bin by the technician. A second quality verification (QV2) 252 is then performed by a pharmacist in response to the system electronically displaying an image on a display of the prescription product to be dispensed according to the prescription to the patient.

The pharmacist as part of his or her workflow then initiates review via the queue-based system, verifies the prescription product on screen using the captured images (QV2), and approves the bagged prescription for customer pick-up if the product is deemed to have been dispensed accurately. The pharmacist may electronically transmit a verification from a location of the pharmacist to a location of the technician and the filled prescription in response to the image of the prescription product being determined at the location of the pharmacist, such as a second site, to be consistent with the prescription. The verified prescription product may then be eligible for purchase 254 by the patient at point-of-sale. If the pharmacist is unable to verify the prescription product via the image (e.g., the picture is blurry, or an image is missing) the pharmacist may opt to systematically send the prescription back to the technician to be re-imaged, or to retrieve the bagged prescription from the waiting bin area to physically inspect the dispensed product themselves.

As noted, steps 242, 244, 246, 248, 250, and 254 may be performed by a technician at a first site, and step 252 may be performed by a pharmacist referencing an image of the prescription product at a second site or separate workstation. Such an aspect allows the technician and the pharmacist to be physically remotely located from one another and eliminates a subsequent handling of the physical prescription product by, for example, the pharmacist.

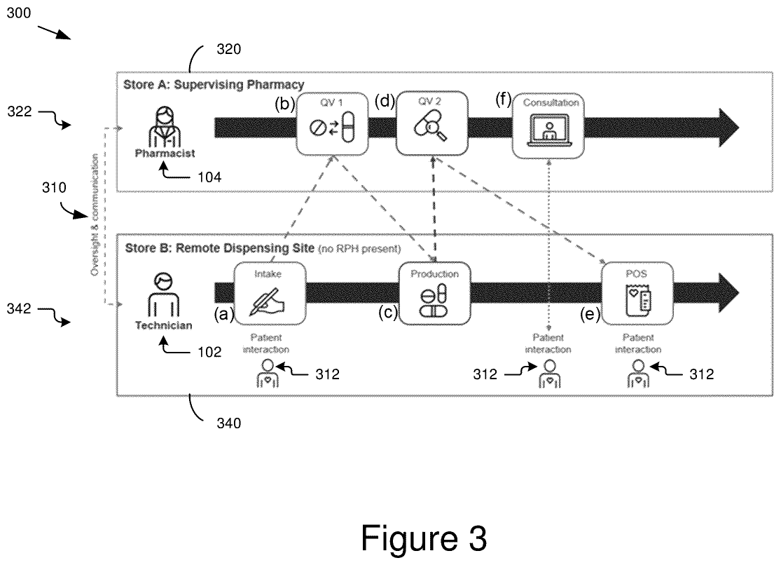

FIG. 3 shows an example of a pharmacy workflow process 300 bifurcated between a supervising pharmacy 320 and a remote dispensing site 340 for verifying a prescription product during a prescription fill process. A telepharmacy or a remote dispensing site 340 (e.g., Store B) may include a technician 102 and operate without a registered pharmacist physically present at that location. The technician 102 at the telepharmacy or remote dispensing site 340 may coordinate with a supervising pharmacy (e.g., Store A) 320 which includes a registered pharmacist 104. The registered pharmacist 104 at the supervising pharmacy 320 may function as a consultant and oversee the operation of the telepharmacy via a communication link 310. The pharmacy workflow process 300 may be bifurcated into a technician workflow 342 at the remote dispensing site 340 and a pharmacist workflow 322 at the supervising pharmacy 320.

For instance, as shown in FIG. 3, the technician workflow 342 may include step (a) interacting with the patient 312 and performing intake by entering the prescription into a pharmacy computing system, step (c) preparing the prescription fill in production and capturing high quality images of the prescription product for the pharmacist 104 to review, and step (e) completing the transaction with the patient 312 at the point of sale after the pharmacist 104 has virtually verified and approved the prescription fill. The pharmacist workflow 322 may include step (b) virtually overseeing the prescription entry by the technician 102 at intake, step (d) virtually verifying and approving the prescription fill by the technician 102, and step (f) consulting virtually with the patient 312 to resolve any issues or address patient's needs.

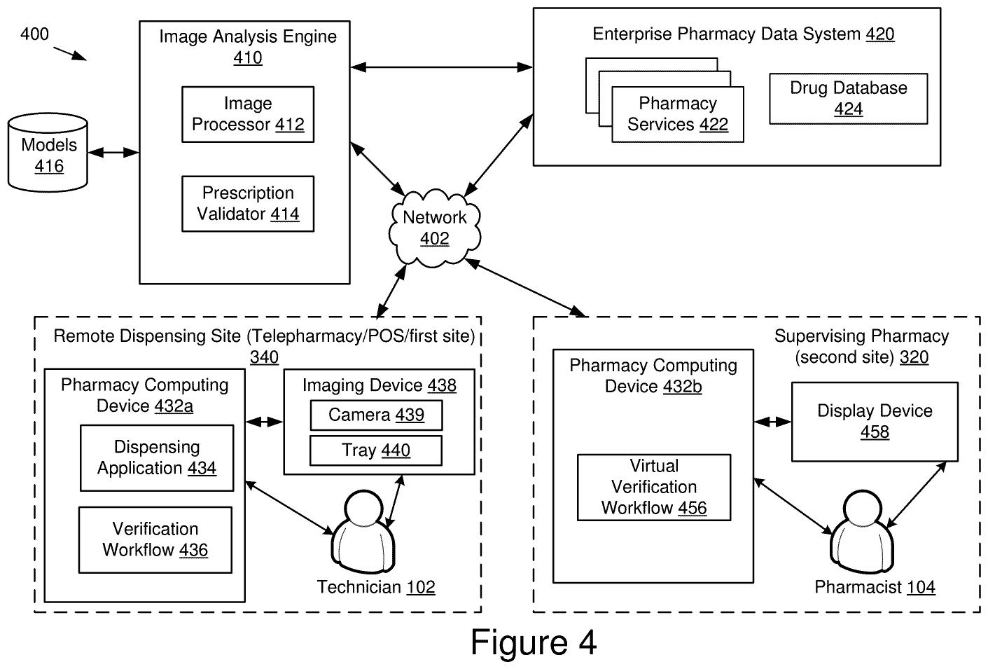

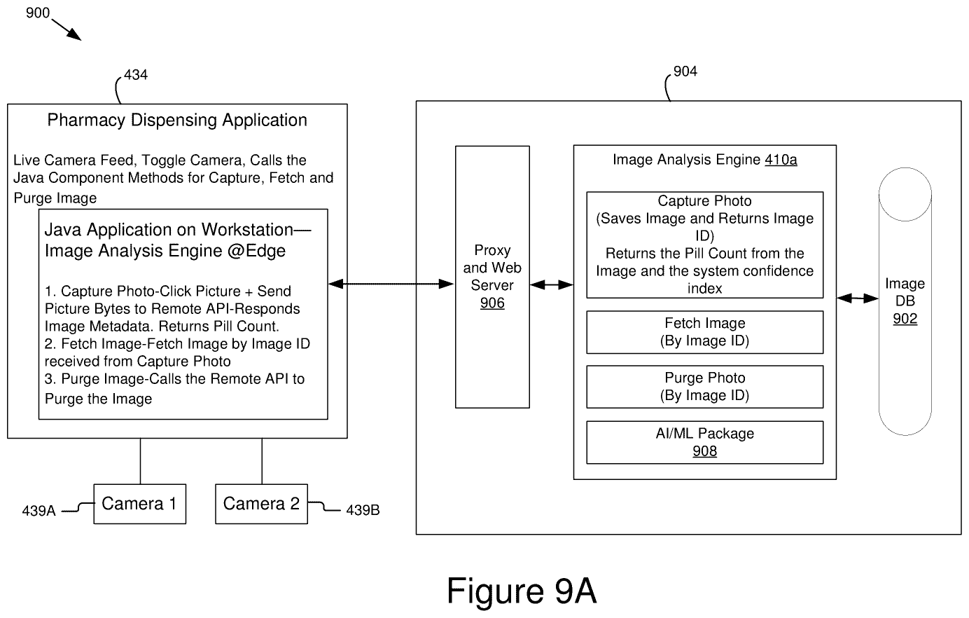

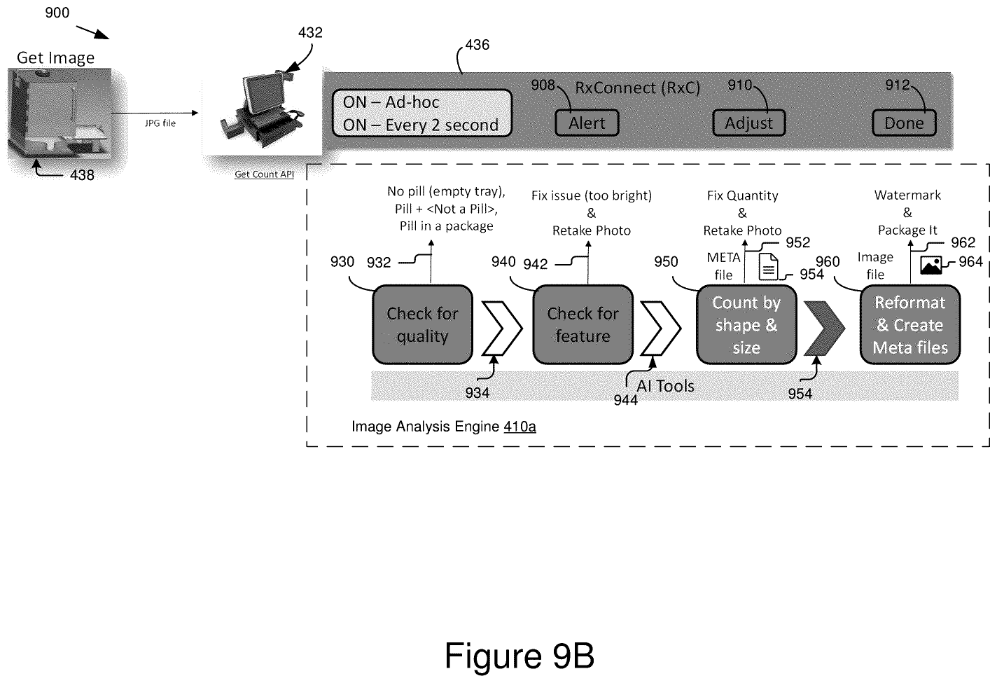

FIG. 4 shows an example implementation of the pharmacy system 400 for image analysis and virtual verification of prescription product used in a pharmacy workflow. As shown in FIG. 4, pharmacy system 400 including remote dispensing site 340 and a supervising pharmacy 320, and an enterprise pharmacy data system 420 may be configured to interact with an image analysis engine 410 to enable virtual verification of prescription product in a pharmacy workflow. As noted previously, the remote dispensing site 340 and supervising pharmacy 320 may be at separate physical sites or may be co-located within the same physical site but physically separated (e.g., at different workstations, in different buildings, in different rooms, etc.). The image analysis engine 410 may be implemented in a combination of software modules supporting the dispensing application 434 and verification workflow 436 at the remote dispensing site or the virtual verification workflow 456, locally on the pharmacy computing device 432a, 432b and/or served over the network 420 from the enterprise pharmacy data system 420. For example, some data and functions may be stored in local data on the pharmacy computing device 432, while other data and functions may be accessed through an API in the enterprise pharmacy data system 420. Examples of the image analysis engine 410a, 410b are shown and described in more detail below with reference to FIGS. 9A, 18, and 19.

In some implementations, a pharmacy system 400 may include a pharmacy computing device 432 and an imaging device 438 including a camera 439. The pharmacy computing device 432a, 432b used by the pharmacist and/or technician may similarly use a combination of local computing resources and network computing resources 402 for coupling with the enterprise pharmacy data system 420. An imaging device 438 may be configured to be coupled to the pharmacy computing device 432 for capturing high quality images of the prescription product. In some implementations, the captured data from the camera 439 of the imaging device 438 may be loaded and adjusted (e.g., white balance, noise reduction, etc.) using the pharmacy computing device 432 and subsequently sent to the image analysis engine 410 for analysis.

The dispensing application 434 may control or receive data from the enterprise pharmacy data system 420 and image analysis engine 410, identify and format the relevant data for presentation to the pharmacist 104 and/or technician 102. In some implementations, the verification workflow 436 may be part of the prescription fulfillment workflow in a pharmacy system 400. In some implementations, the information for presentation to the pharmacy staff may be displayed on a visual interface 458 of the pharmacy computing device 432. There may be multiple pharmacy systems 320/340 configured to interact with each other and the enterprise pharmacy data system 420. For example, it may be that some retail pharmacies function as supervising pharmacies 320 and house a pharmacist 104 to oversee and verify the prescription workflow of a technician 102 in a telepharmacy or other remote location.

In some implementations, the enterprise pharmacy data system 420 may host a number of pharmacy services 422 and a drug database 424. For example, pharmacy services 422 may include prescription reorder, prescription delivery, linkage to specific savings programs, subscription fill services, bundling additional prescriptions for refill/pickup, automating next refill, conversion to 90-day prescriptions, clinic services, flu shots, vaccines, non-prescription products, etc. The drug database 424 may include information about prescription and over-the-counter medication. In particular, the drug database 424 may include proprietary or in-house databases maintained by pharmacies or drug manufacturers, commercially available databases, and/or databases operated by a government agency. The drug database 424 may be accessed using industry standard drug identifiers, such as without limitation, a generic product identifier (GPI), generic sequence number (GSN), national drug code directory (NDC), universal product code (UPC), health related item, or manufacturer.

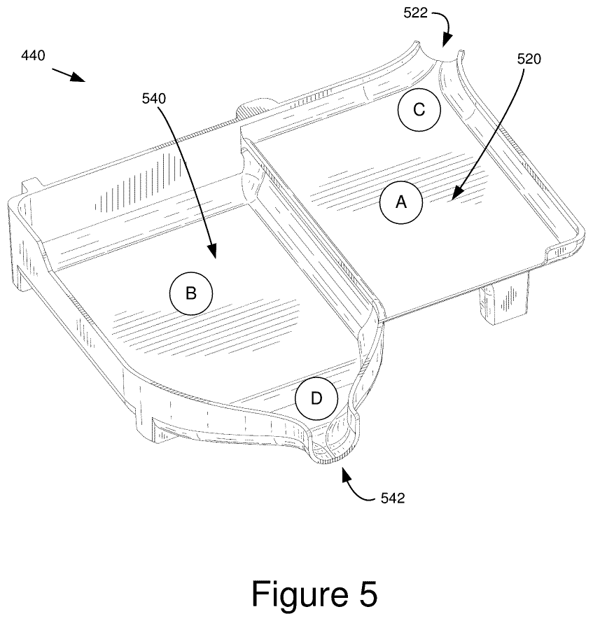

The imaging device 438 via camera 439 may support imaging prescription products of all types. In some implementations, the imaging device 438 uses a Counting and Imaging Tray (CAIT) 440 as shown in detail in FIG. 5.

In FIG. 5, the CAIT 440 may be used by a pharmacy staff member, such as technician 102, to both count and take an image of the prescription, such as pills without needing to dump the pills from the tray into another container or tray for capturing images. As shown in FIG. 5, the pharmacy staff member may:
1—Pour pills from a stock bottle of the prescription product onto a first portion or a counting level (A) 520 during a prescription workflow;
2—Count and swipe the prescribed quantity of pills onto a second portion of imaging level (B) 540;
3—Pour the remaining amount on the counting level (A) back into the stock bottle via a spout or chute (C) 522 at one of the corners of the counting level (A) 520;
4—Slide the CAIT 440 into the imaging device 438 to capture one or more images of the prescribed quantity; and
5—Pour the contents into a vial or bottle via another spout or chute (D) 542 at one of the corners of the imaging level (B) 540.

As shown in FIG. 5, the CAIT 440 is particularly advantageous because of the different spouts or chutes(C) 522 and (D) 542 for inputting and dispensing the prescription, the different layers at different heights for counting and imaging, and the walls around each layer of the CAIT that are sloped or angled to bias or direct the pills towards the next area of processing from input spout or chute (C) to output spout or chute (D). In one aspect, the CAIT is further configured with at least one slope within the second portion of the tray (e.g., imaging level (B) 540) to bias the pills toward the field of view of the camera 439 in the imaging device 438.

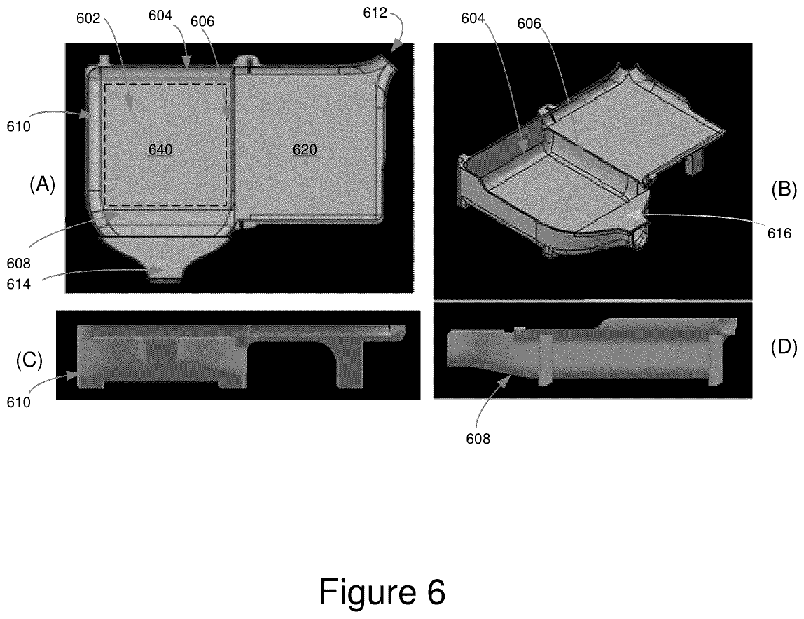

FIG. 6 illustrates different views of the CAIT used in conjunction with an imaging device. The CAIT 440 is illustrated with respect to various views (A)-(D). The CAIT 440 is illustrated as including a counting or first portion 620 and an imaging or second portion 640. The counting or first portion 620 is similar to the first portion/counting level (A) 520 in FIG. 5 and the imaging or second portion is similar to the second portion/imaging level (B) 540 in FIG. 5. The imaging portion 640 is illustrated as including a field of view area 602 which is formed in response to various sloped contours 604, 606, 608, and 610 within the imaging portion 640 that bias or direct prescription product into the field of view area 602. As in FIG. 5, CAIT 440 includes two spouts or chutes, a first chute 612 in communication with the first/counting portion 620 and a second chute 614 in communication with the second/imaging portion 640. Further, the CAIT 440 is also illustrated to include top cap 616 to assist in retaining the prescription product in the imaging portion 640 when the product is poured from the CAIT 440 into a vial (e.g., pill bottle).

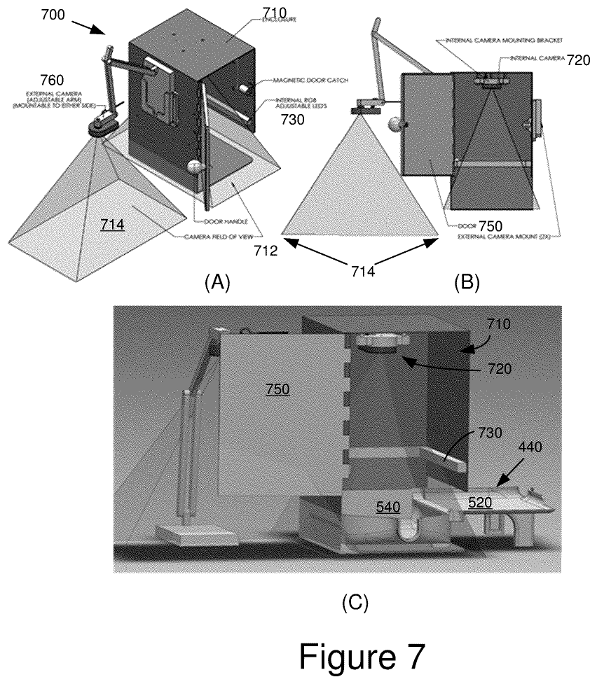

FIG. 7 illustrates an example imaging device 700. In one aspect, a first camera 720 configuration is illustrated for capturing high quality images of the prescription product using a CAIT 440. In another aspect, a dual camera (e.g., first camera 720 and second camera 760) configuration is illustrated for capturing high quality images of the prescription product using a CAIT 440. In FIG. 7, various views (A)-(C) are presented. In view (A), a perspective view of the imaging device 700 is illustrated. In view (B), a frontal cross-sectional view is illustrated. In view (C), a configured view is illustrated that shows the CAIT 440 inserted into the imaging device 700.

The imaging device 700 includes an enclosure 710 for housing and supporting various structures, including a first camera 720. The first camera 720 is configured to attach above a working surface to provide a field of view 712 over the working surface. Further, the field of view corresponds to the imaging level 540 of CAIT 440. The first camera 720 is illustrated as being attached to the top inner surface of enclosure 710.

The enclosure 710 further includes a door 750 configured to provide access to the imaging level 540 of CAIT 440 when the CAIT 440 is inserted into the imaging device 700. In operation, the CAIT is inserted into the imaging device 700 and the door 750 is closed. The interior of the imaging device in the field of view 712 is protected from intermittent exterior lighting variations. Accordingly, to provide improved lighting conditions for the first camera 720 to capture images of prescription product in the imaging level 540 of the CAIT 440, the imaging device 700 may further include one or more lights 730. In one example, the lights 730 are configured to illuminate the second portion or the imaging level 540 of the CAIT 440. For example, the lights 730 may be a row of lights surrounding multiple sides of the inside of enclosure 710.

The imaging device 700 may include a second camera 760 coupled to an exterior surface of enclosure 710. The second camera 760 may be utilized when imaging prescription product needing a field of view 714 greater than the field of view 712 within the enclosure. For example, if a tray including prescription product is too large to be received within the enclosure 710, then the external or second camera 760 may be utilized. In other implementations, the second camera 760 may also be used for additional capacity by the imaging device 700.

With respect to FIG. 7, in one use case, the pharmacy staff member may slide the CAIT 440 containing prescription production (e.g., loose pills) on the imaging level 540 into the imaging device 700 and capture images of the imaging level 540 using the first camera 720, for example, an internal high definition (HD) camera inside the imaging device. In another use case, the pharmacy staff member may open the imaging device to place boxes and stock bottles inside the imaging device 700 to capture one or more images without using the CAIT 440. In yet another use case, the pharmacy staff member may switch to an external or second camera 760 affixed to the imaging device 700 or a stand-alone camera coupled to the imaging device 700 to capture images of prescription products that do not fit inside the imaging device.

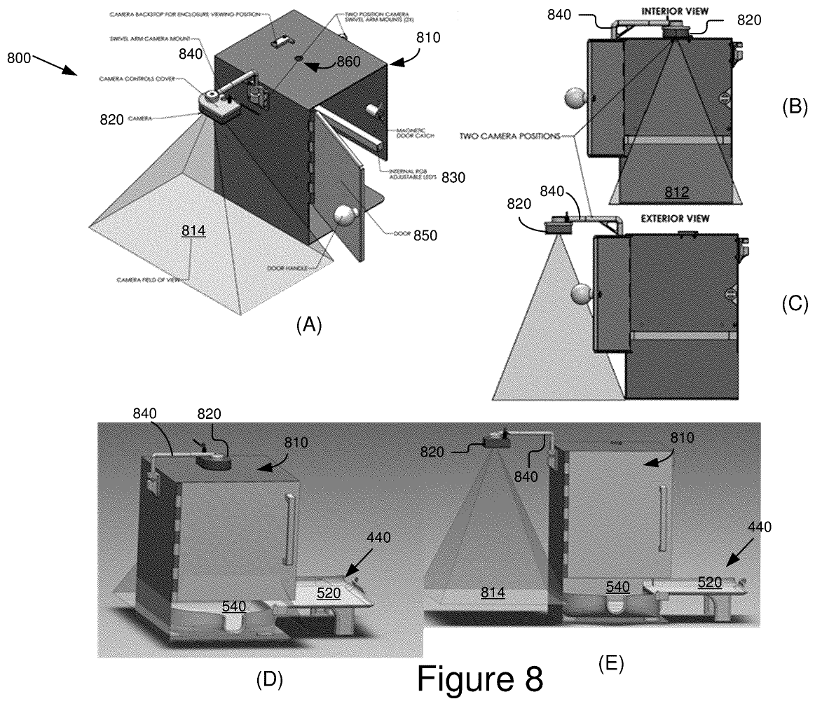

FIG. 8 illustrates an example imaging device 800 using a single camera 820 configuration for capturing high quality images of the prescription product using a CAIT 440. In FIG. 8, various views (A)-(E) are illustrated to show the imaging device 800 from various perspectives and in various states of use. The imaging device 800 includes an enclosure 810 and may include a door 850 and lights 830 corresponding to the elements described with respect to FIG. 7. The implementation illustrated in FIG. 8, utilizes a single camera 820 for capturing images within the enclosure (see views (B) and (D)), and for capturing images outside of the enclosure (See views (A), (C), and (E)). To accommodate capturing images in both positions using a single camera 820, the imaging device 800 includes a swiveling support arm 840 maneuverable between a first position placing the camera 820 over an aperture 860 to facilitate capturing images of prescription product within a field of view 812 inside of the enclosure 810, and a second position placing the camera 820 extending from the enclosure 810 to facilitate capturing images of prescription product within a field of view 814 outside of the enclosure 810. The swiveling support arm 840 may couple to a portion of the enclosure 810 to provide adequate displacement between the first and second positions.

In some implementations as illustrated with respect to FIG. 4, FIG. 7 and FIG. 8, the camera (internal and external) coupled to the imaging device may provide a livestream of the image preview to the display of a pharmacy computing device 432 to aid the technician (e.g., staff member) in using the CAIT 440 with the imaging device 700/800. In some implementations, the imaging device transmits the images captured and/or camera livestream to the pharmacy computing device for processing (e.g., white balancing) and image analysis (e.g., prescription count). In some implementations, the imaging device transmits the images captured and/or camera livestream to the image analysis engine 410 for processing and image analysis.

In some implementations, the image analysis engine 410 may include an image processor 412 and a prescription validator 414. The image processor 412 works in conjunction with the dispensing application 434 at the pharmacy computing device 432 to capture, store, retrieve, and delete images of prescription product. In some implementations, the dispensing application 434 sends the captured images from the imaging device to the image processor 412. The image processor 412 receives the image and processes the image. For example, the image processor 412 corrects white balance in the image. The image processor 412 creates an image identifier to associate with the image. The image processor 412 stores the image and the corresponding image identifier in a data storage associated with the image analysis engine.

In some implementations, the image processor 412 receives a request to delete one or more images of a prescription product from the dispensing application 434. The image processor 412 identifies one or more images of the product using an associated image identifier and accordingly deletes the images in the data storage. In some implementations, the image processor 412 may retrieve an image of the prescription product from the data storage and send it to the dispensing application 434 in response to receiving an image identifier corresponding to the image. For example, a pharmacist may retrieve images of prescription product to verify the prescription fill during a verification workflow on the pharmacy computing device.

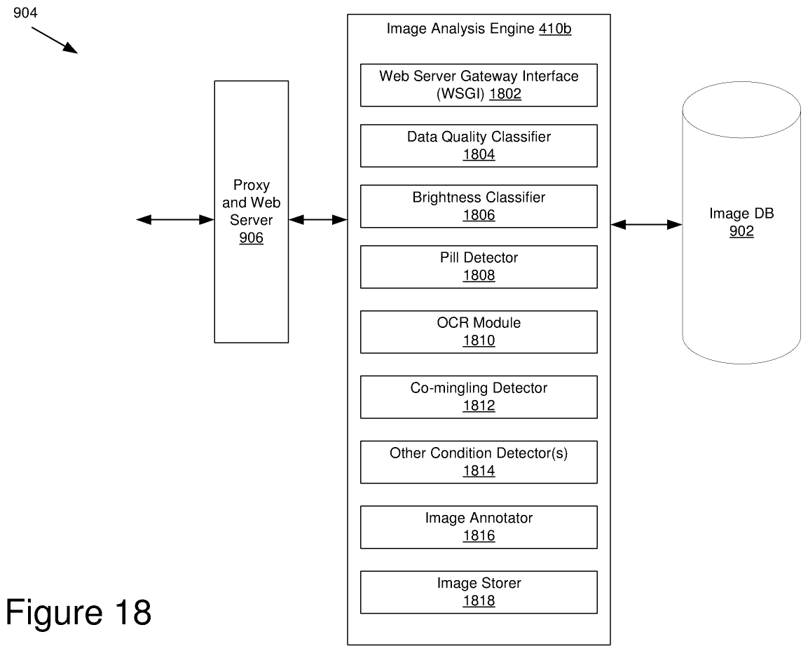

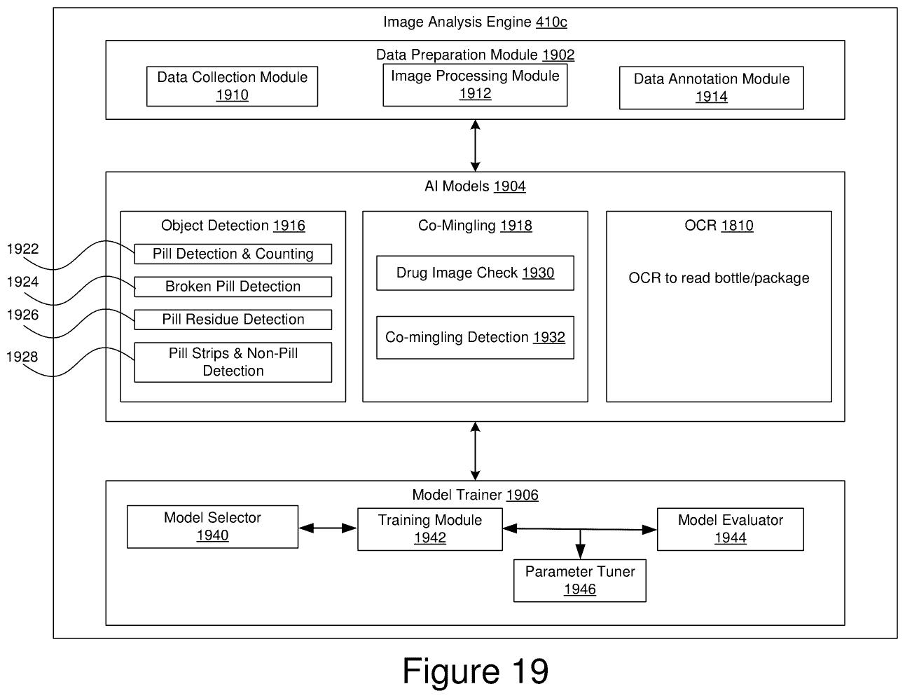

Referring now also to FIG. 9A, an example high level architecture 900 is shown depicting an interaction between the pharmacy dispensing application 434 and an image analysis engine 410a for implementing virtual verification. The image analysis engine 410a may be operational on a system 904 including a proxy and web server 906 coupled for communication and interaction with pharmacy dispensing application 434. The system 904 may include another server upon which the image analysis engine 410a operates and an image database 902. In some implementations, the prescription validator analyzes the image from the image database 902 captured by camera 439 for determining a count of prescribed pills and flags the image if the count does not match the prescription. In one example, the dispensing application 434 may support a live camera feed, toggle between cameras 439A and 439B, and call the Java components for capture, fetch, and purge image(s). In one example, the image analysis engine 410a may capture the image, save the image, return an image ID, and return a pill count from the image and also return a system confidence index. In some implementations, the image analysis engine 410a includes artificial intelligence and machine learning components to detect and identify problem conditions, generate alerts or warnings, send alerts or warnings, or take appropriate action. See the AI/ML package 908 in FIG. 9A. For example, problem conditions may include, but are not limited to, blurred images, heterogeneous pills on a tray, defective or broken pills, pill strips, non-pill objects, stacked pills, pills not fully in the image, etc. Example implementations for the image analysis engine 410b, 410c with these artificial intelligence and machine learning capabilities are shown and described in more detail below with reference to FIGS. 18 and 19. The AI/ML package 908 may include artificial intelligence or machine learning models. The artificial intelligence or machine learning model may be steps, processes, functionalities, software executable by a processor, or a device including routines for implementing the prescription product condition detection that will be described below. In general, training the machine learning model may involve training using data from pharmacists, pharmacist technicians, users, experts, employees, automated data feeds from third parties, or some combination thereof. The machine learning model may be geometric systems like nearest neighbors and support vector machines, probabilistic systems, evolutionary systems like genetic algorithms, decision trees, neural networks associated with decision trees, convolutional neural networks, Bayesian inference, random forests, boosting, logistic regression, faceted navigation, query refinement, query expansion, singular value decomposition, a Markov chain model, and the like. The artificial intelligence or machine learning models may use supervised learning, semi-supervised learning, or unsupervised learning for building and training the machine learning systems based on the type of data available and the particular machine learning technology used for implementation. In some implementations, one or more machine learning models may be used to determine the particular prescription product condition or request for additional information.

FIG. 9B shows an example flow diagram for processing an image. In some implementations, a process 900 generated image at imaging device 438. In some implementations, a pharmacy computing device 432 may couple to an imaging device 438. In some examples, the imaging device 438 may be configured to capture an image of prescription product and transfer that image, for example in a JPEG file, to the pharmacy computing device 432. The pharmacy computing device 432 may initiate, for example, an API call to the image analysis engine 410a. Image analysis engine 410a may include or access various artificial intelligence (AI) tools that operate in conjunction with various models 416 of FIG. 4.

The various AI tools may include a data classifier 930 configured to look for a quality of the image, for example, attempts to identify shapes that may be consistent with the shapes of the prescription product (e.g., pills). In some examples, when the data classifier 930 fails to identify shapes consistent with the prescription product, an exception 932 is generated which may create an alert 908 and a verification workflow 436. The alert 908 may also generate an adjustment request 910 which specifies a manual adjustment or removal of items from a CAIT 440 or the field of view of the camera in the imaging device 438.

In response to the data classifier 930 determining that the image includes shapes consistent with the prescription product, the data classifier 930 advances processing 934 to a data classifier 940. The data classifier 940 is configured to look for features of the image, for example, to determine the brightness of the image. In some examples, when the data classifier 940 determines that the features in the image are, for example, too bright or too dim, the data classifier 940 generates an exception 942 which may generate an alert 908 and the request for adjustment 910 to retake the photo.

In response to the data classifier 940 determining that the image includes identifiable features, the data classifier 940 advances processing 944 to a data classifier 950. The data classifier 950 is configured to count individual features in the photo to generate a specific count of the quantity of prescription product. In response to the data classifier 950 determining that the quantity may not be calculated, for example, based upon ones of the prescription product being stacked, or otherwise only partially visible, the data classifier 950 generates an exception 952 designating the quantity as being unresolvable. The data classifier 950 may also generate a metafile 954 designating a partial count of the prescription product. The exception 952 may also generate a manual adjustment request 910 instructing a user to manually adjust (e.g., unstack pills) prescription product in the field of view of the camera of the imaging device 438.

In response to the data classifier 950 resolving or generating a count of the prescription product, the data classifier 950 advances processing metafile 954 to data classifier 960. In some examples, the data classifier 960 reformats the image by placing a watermark on the image 964 for use and tamper identification. The data classifier 960 also creates a metadata (e.g., meta file) that may include a quantity count and other identifiable information relevant to the prescription product. The metadata and modified image 964 may be output 962. The output 962 may also instruct the verification workflow 436 to package (e.g., fill the vile) with the prescription product. Once the prescription product is packaged, the technician can designate the workflow as complete by asserting a done signal 912.

It should be noted that while multiple models have been illustrated, a lesser or greater number of models may be employed by adjusting the sophistication of each of the models. Further, the image analysis engine 410a may employ machine learning that utilizes deep learning, employs models that may detect only certain types of pills, or may include models that are trained for various characteristics including shape, size, color, and embossments on the prescription product.

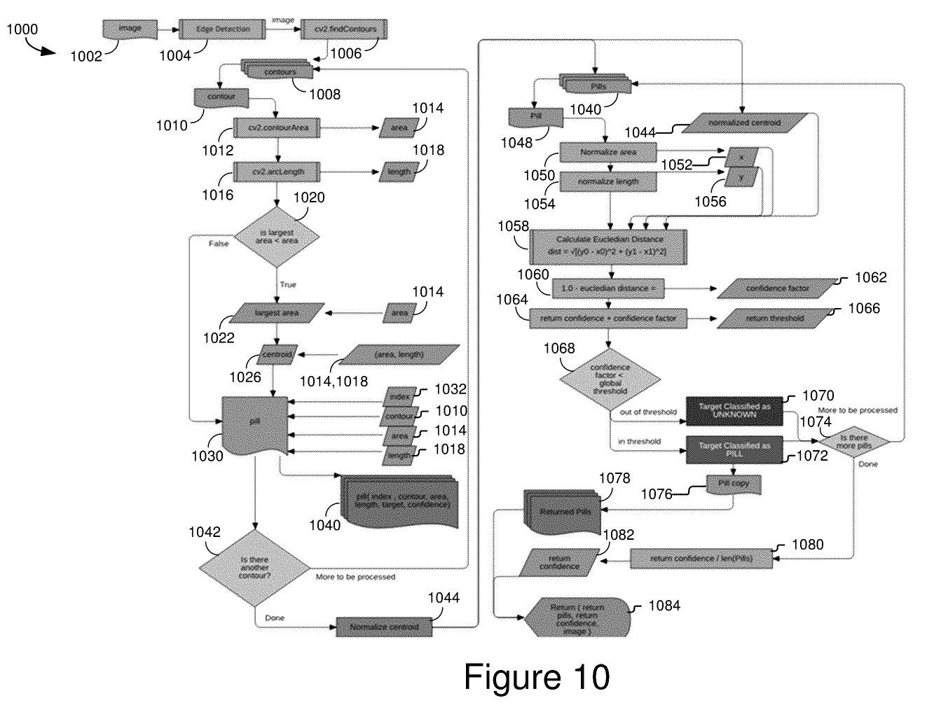

FIG. 10 describes a process 1000 implemented by the prescription validator 414 for counting an amount of the prescription product in an image and returning a confidence interval associated with any mismatch in the count. In some implementations, the prescription validator analyzes the image using artificial intelligence (e.g., one or more machine learning models) to identify the type of prescription pill in the image. For example, the prescription validator may analyze the image to detect any anomaly (e.g., presence of an ibuprofen pill mixed in with pills for treating blood pressure) in the total count of pills in the image. The machine learning models may be previously trained using an appropriate data set of images to predict a label for a particular type of pill in an image. Examples of machine learning models may include but are not limited to k-nearest neighbors, convolutional neural network, support vector machines, decision trees, Bayesian networks, random decision forests, linear regression, least squares, other machine learning techniques, and/or combinations of machine learning techniques.

In one implementation, an image 1002 is captured as previously described, and a process 1004 performs edge detection on the image. The edges are used in a process 1006 to identify contours. The contours are stored as contours 1008 with a current one being processed as contour 1010. A process 1012 determines an area 1014 of the current contour 1010. Process 1016 determines an arc length 1018 for the current contour 1010. The comparison 1020 compares the area 1014 with a previously stored area. When the area 1014 is greater than the previously stored area then the area 1014 is stored as the largest area 1022. In a process 1026, a centroid is determined from the previously determined area 1014 and length 1018. A process 1030 determines from inputs of index 1032, contour 1010, area 1014, and length 1018 if the combination of the inputs is consistent with the identification of the pill. Accordingly, the result of pills 1040 is stored as a pill with an index, contour, area, length, target, and confidence level. A query process 1042 determines if there is another contour, meaning more contours to be processed. When more contours are determined, processing returns to processing the next contour.

When query 1042 determines that there are no other contours to be processed, a process 1044 normalizes the centroid. The pills 1040 are then analyzed one pill at a time starting with a pill 1048. Process 1050 normalizes the area and generates a normalized area 1052. A process 1054 normalizes the length and generates an output 1056. Process 1058 determines a distance based upon the normalized area, the normalized length, and the normalized centroid. A process 1060 determines a confidence factor 1062.

A process 1064 determines a return threshold 1066. The threshold is used in query to gauge a confidence factor that a determined pill was likely detected. A query 1068 determines whether the confidence factor is less than the global threshold. If the confidence factor is out of the threshold, then the target area is classified as unknown 1070. If the confidence factor is within the threshold, then the target area is classified as a pill 1072. Further, if the confidence factor is within the threshold, a pill copy 1076 is generated and stored as returned pills 1078. A pill copy 1076 is an image that was classified to be a pill based on the above process.

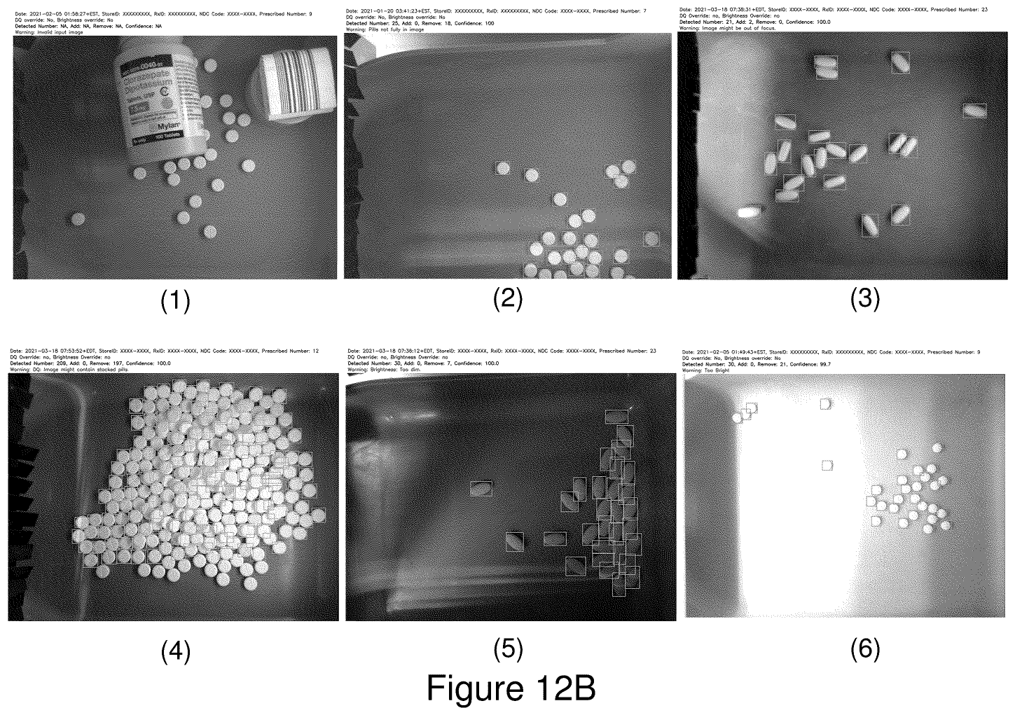

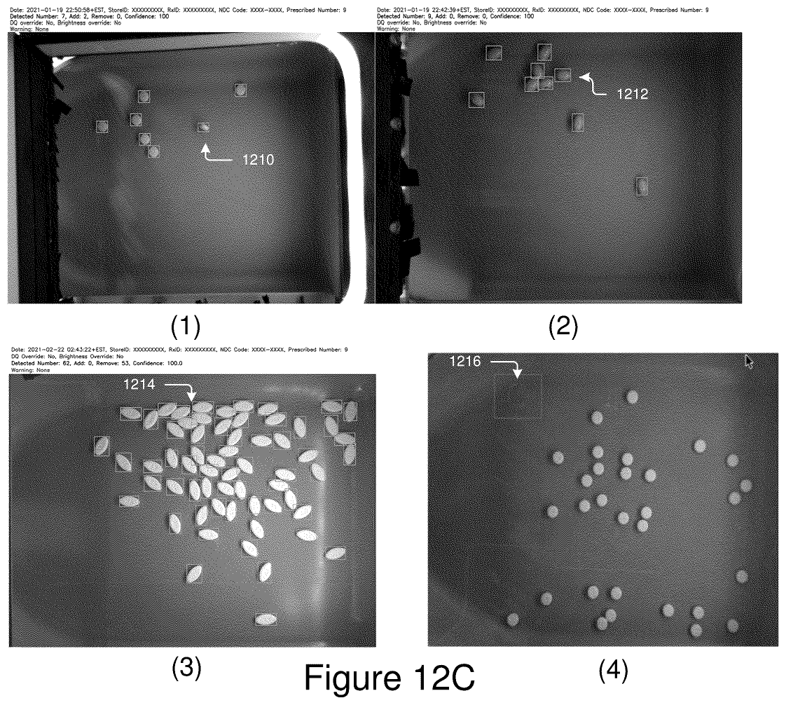

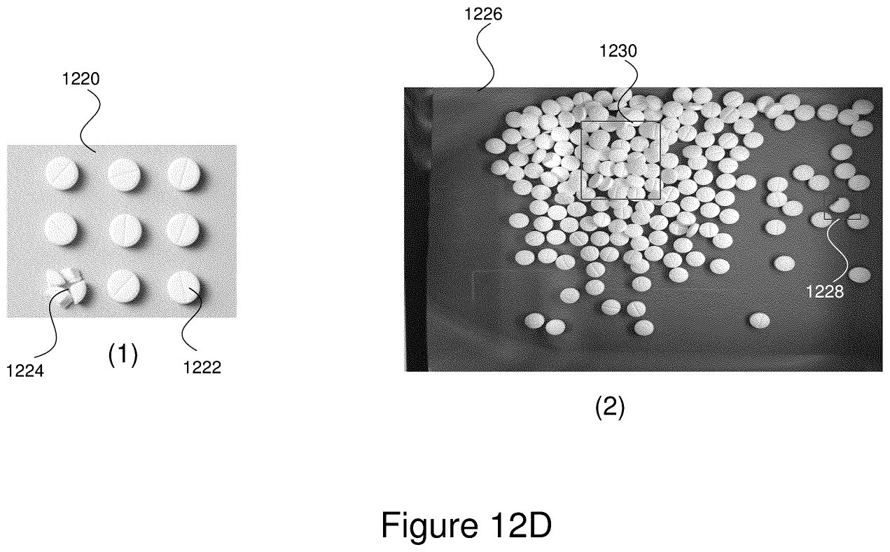

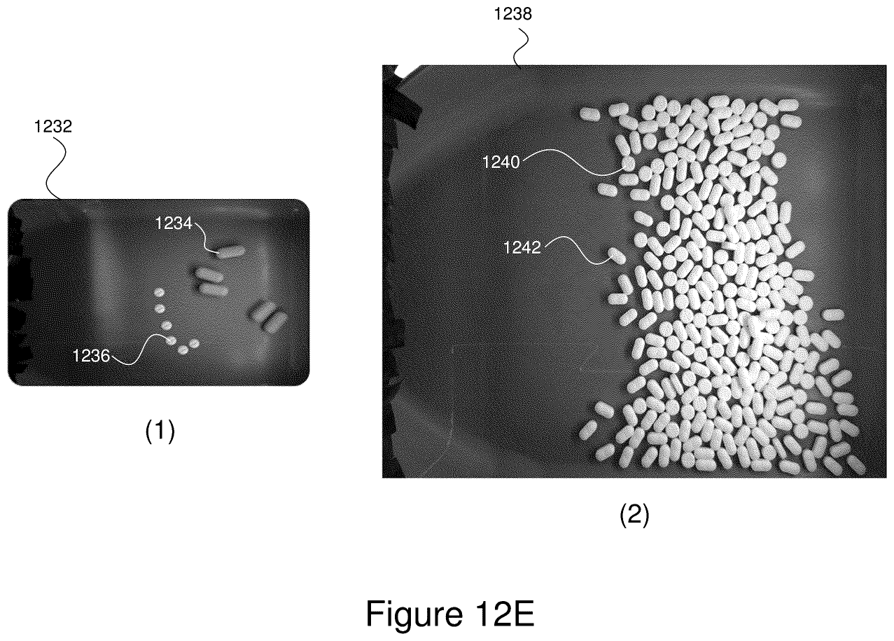

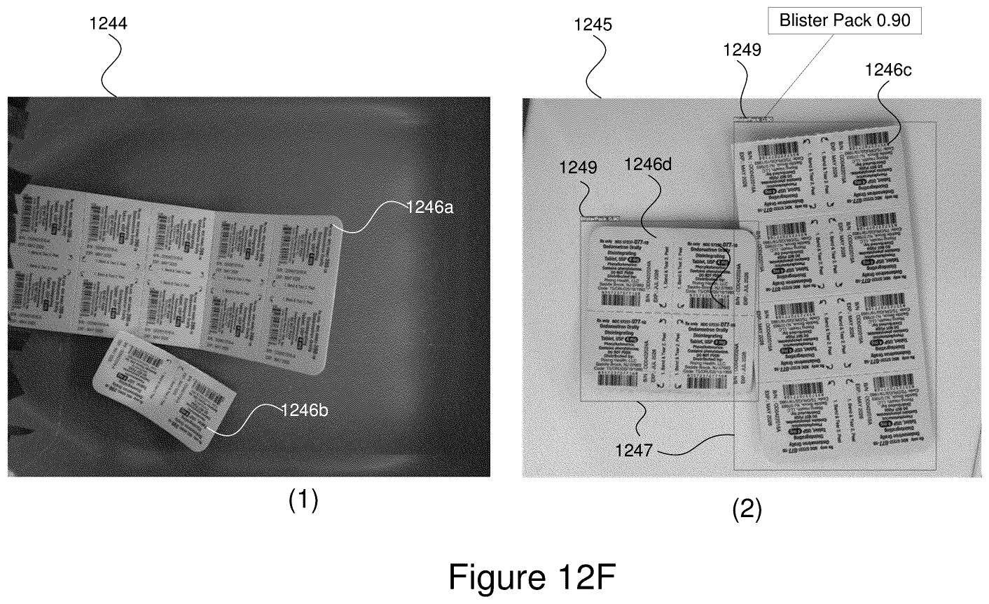

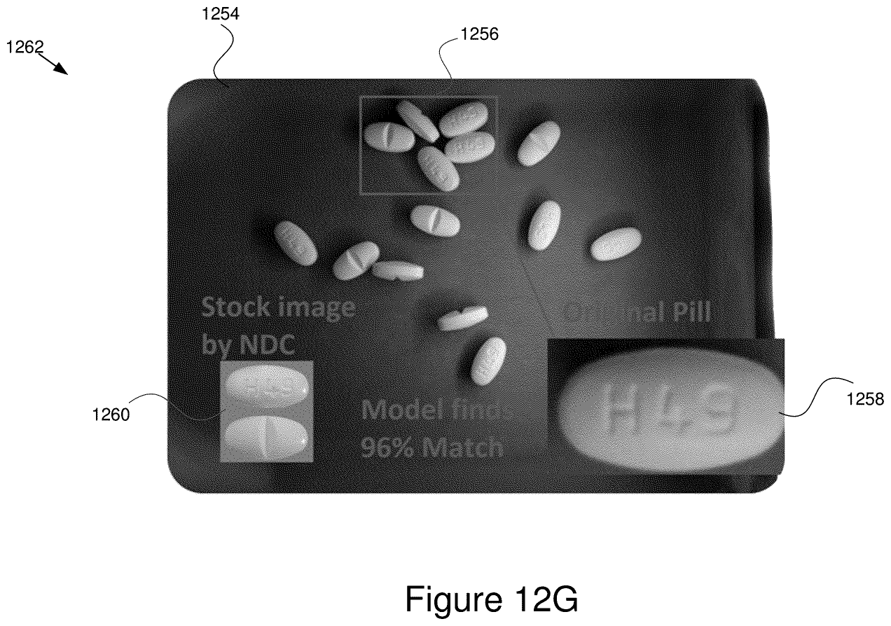

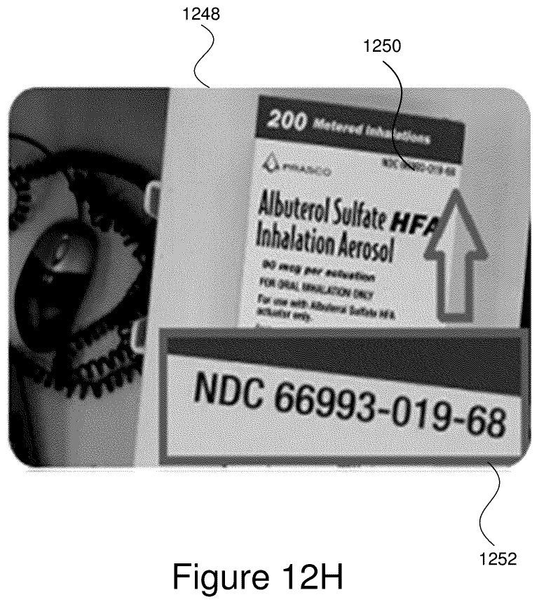

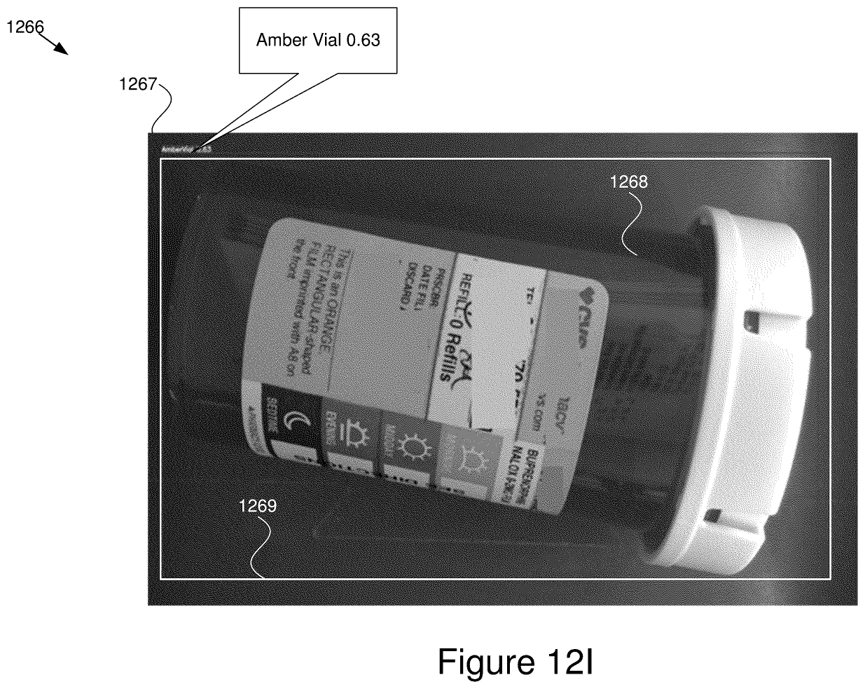

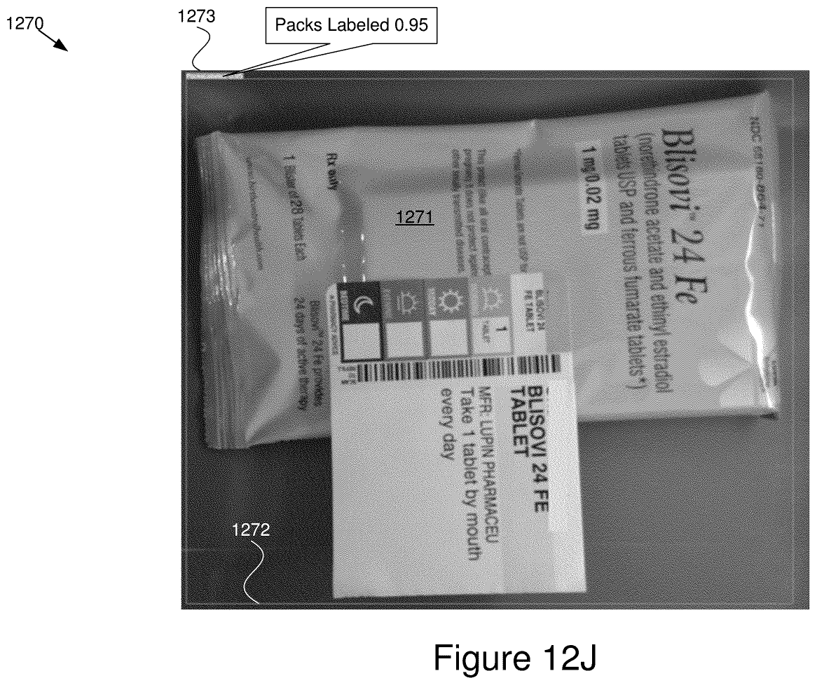

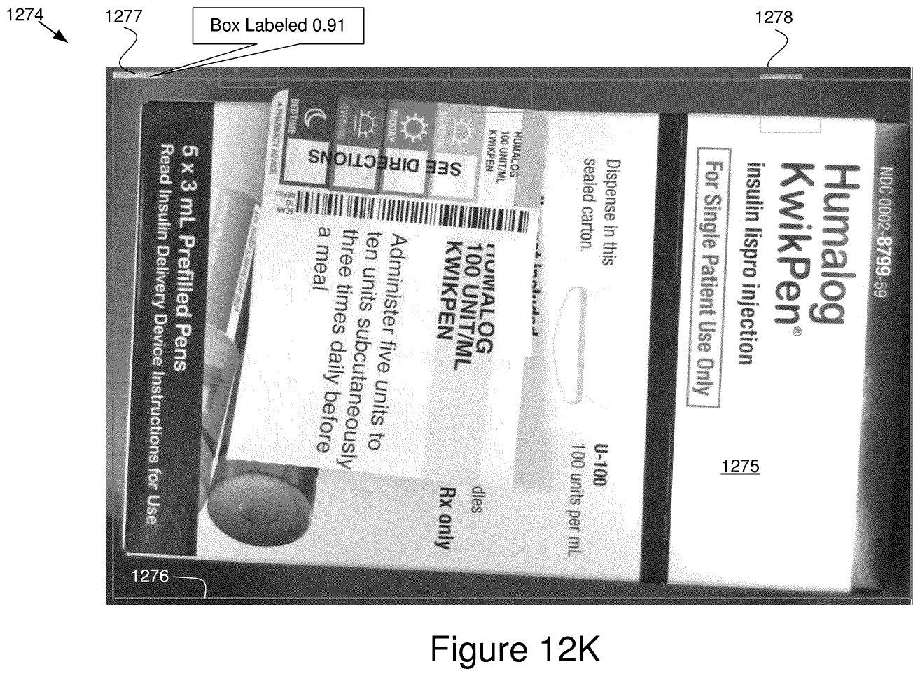

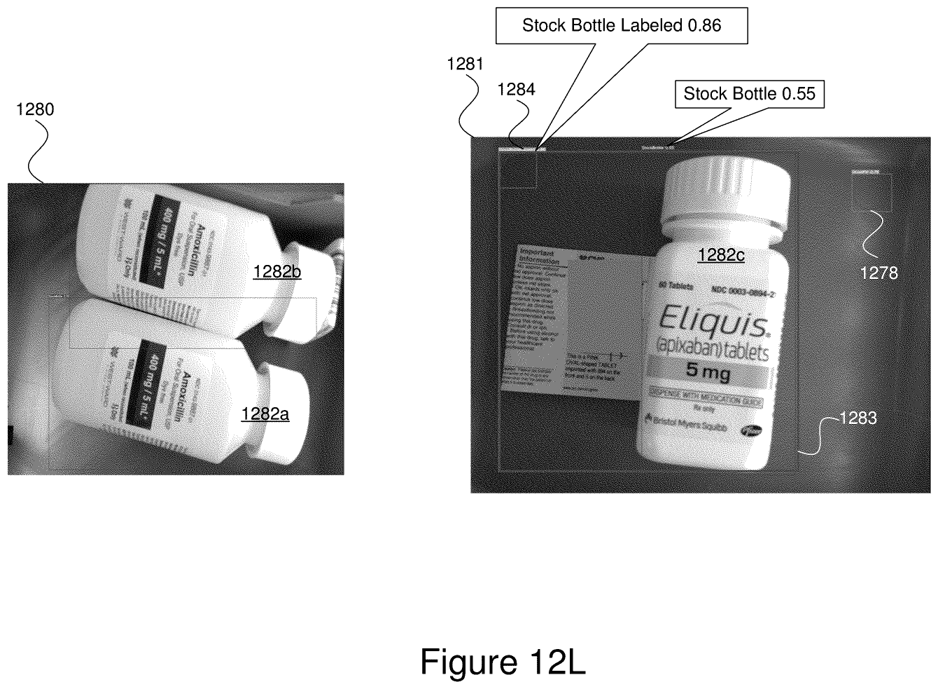

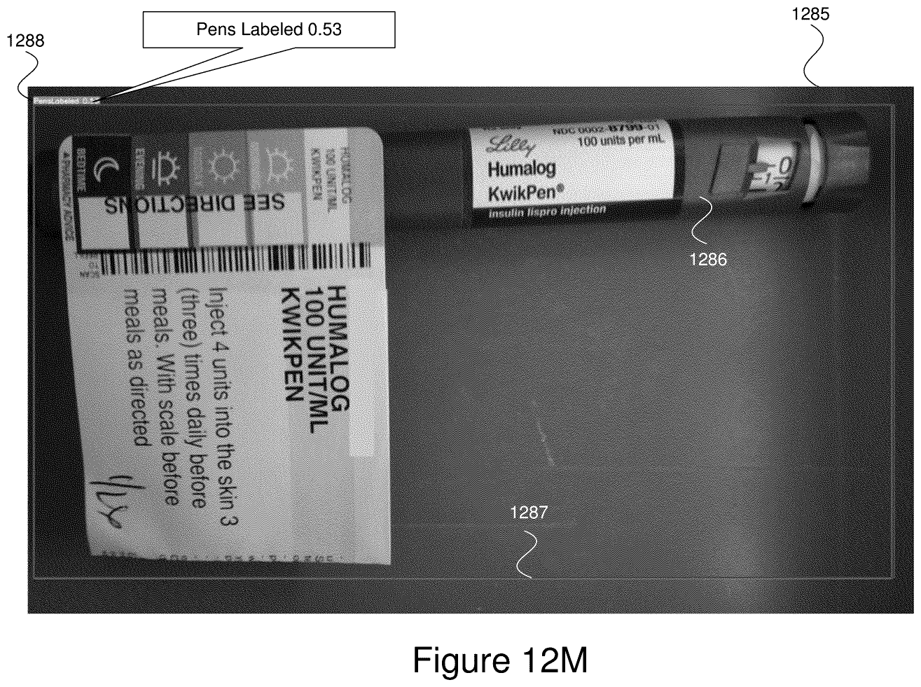

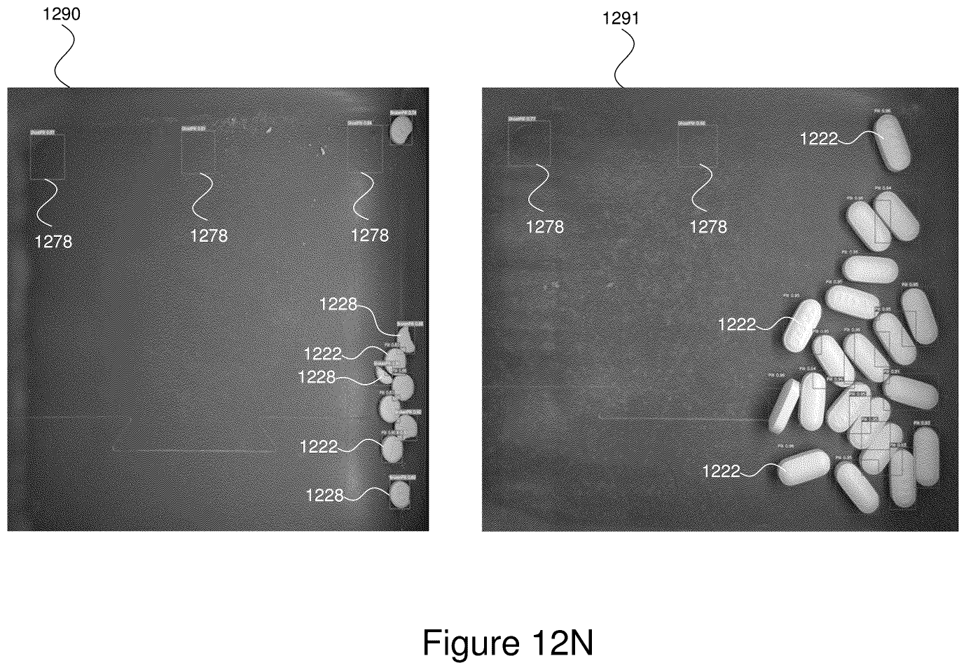

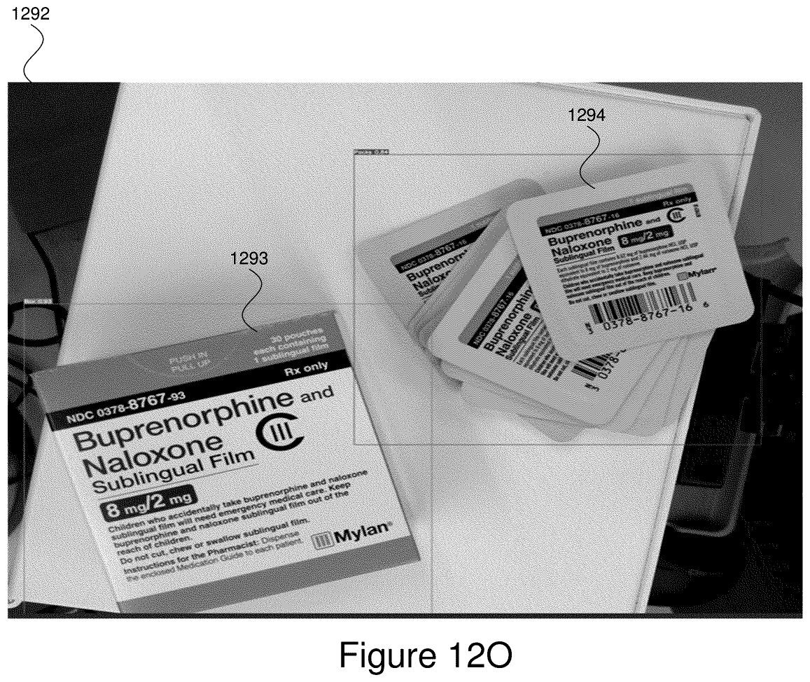

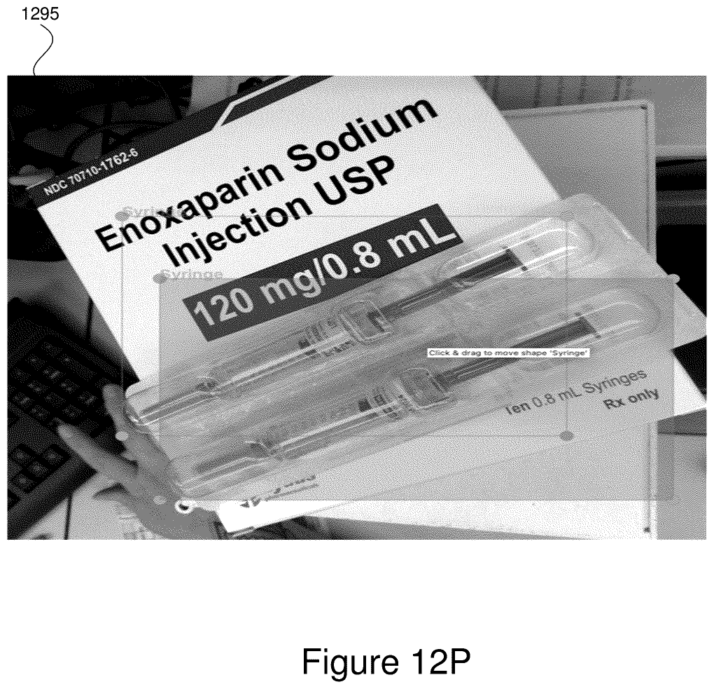

When a query process 1074 determines there are more pills for processing, then processing returns to process the next pill 1040. When the query process 1074 determines there are no more pills for processing, then a process 1080 returns a confidence per pills resulting in the generation of a return confidence 1082. The process then generates an output 1084 based upon the pill count, the confidence, and the image. Specifically, the pill count, confidence factor/level, and image are illustrated below with respect to the outputs illustrated in FIG. 12C.

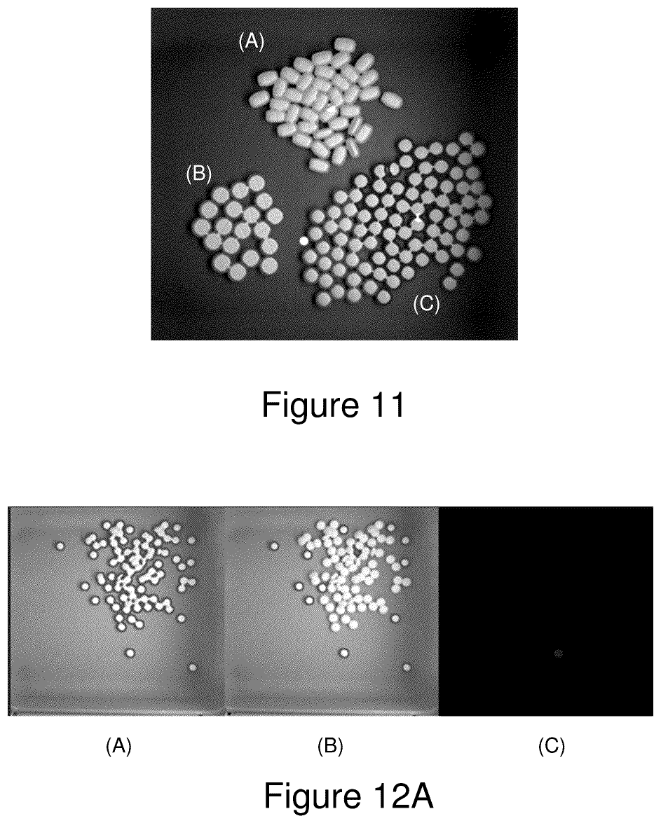

FIG. 11 shows a graphic representation of an example output obtained from analyzing an image of pills using K-nearest neighbors or K-means clustering. Illustrated is an example of K-nearest neighbor supervised machine learning training for pill classification. In some implementations, image segmentation or templating can be used to cluster groups (A), (B), and (C) of detected pills or find anomalies. This is the process of slicing the image into several layers, then iterating a kernel across each slice. This is an example of a heterogeneous pill mix detected by the image analysis engine 410 using artificial intelligence or machine learning, and the identification of the different pill types in the heterogeneous pill mix called out with distinct colors of image highlighting.

FIG. 12A shows an example output obtained from analyzing an image of pills using the process described with respect to FIG. 10. Illustrated is an artificial intelligence (AI) segmentation/slicing of images to identify anomalies or comingling of pills. Specifically, view (A) illustrates an input image, view (B) illustrates an intermediary step, and view (C) illustrates an output of the process with an anomaly detected. In some implementations and with reference to FIG. 4, the prescription validator 414 may be instantiated within the dispensing application 434 on the pharmacy computing device 432 and configured to receive a livestream feed from the imaging device 438 and analyze the images in the livestream feed to count and identify the number of pills on-the-fly. In some implementations, the image analysis engine 410 may include a data feed from the enterprise pharmacy data systems 420 to the prescription validator 414 to support counting and differentiation of pills identified in the images.

In some implementations, the dispensing application 434 coordinates with the verification workflow 436 to generate workflow interfaces to implement an end-to-end prescription fill process. The following figures include a variety of example screen shots of dispensing application 434 on a pharmacy computing device 432 used to implement an end-to-end prescription fill process.

FIG. 12B illustrates various views including captured images of the prescription product in the field of view of the camera of the imaging device. Illustrated is an AI annotation of captured images with various image quality alerts notifying, for example, a technician or pharmacist of an issue that impacting the ability of the model to accurately assess the image. The various views (1)-(6) of FIG. 12B include example images that generated various alerts 908 of FIG. 9B with respect to quality checks of the images. In view (1), the image is rejected with an alert (e.g., warning) generated because other artifacts (e.g., non-pill object like a pill bottle, lid, instructions) beyond those elements identified as prescription product are present within the field of view. In view (2), the image is rejected with an alert (e.g., warning) generated because the elements of the prescription product are not entirely within the field of view, as noted by the different highlighting associated with the presence of partial pills at the edge of the image. In view (3), the image is rejected with an alert (e.g., warning) generated because the image is out of focus or blurred. In view (4), the image is rejected with an alert (e.g., warning) generated because the image includes prescription product that are stacked on each other thereby resulting in the inability to count the individual pills in the prescription product. In view (5), the image is rejected with an alert (e.g., warning) generated because the image is underexposed (e.g., dim) with non-uniform lighting, resulting in the inability to distinguish individual pills in the prescription product. In view (6), the image is rejected with an alert (e.g., warning) generated because the image is overexposed with non-uniform lighting, resulting in the inability to distinguish individual pills in the prescription product. The above alerts relating to image rejections were further described above with respect to FIG. 9B.

FIG. 12C illustrates various views including captured images of the prescription product in the field of view of the camera 439 of the imaging device 438. Illustrated is an AI annotation of captured images with dispensed quantity alerts. The various views (1)-(3) of FIG. 12C include example images that were acceptable and did not generate alerts (e.g., warnings) in the check for quality process described above with respect to FIG. 9B. In view (1), the quality of the image is acceptable and results in resolution of each of the pills in the field of view. The dispensed quantity is less than the target or prescribed quantity. Specifically, a pill 1210 that is located on its edge is still resolved and included in the count of the pills in the prescription product. In view (2), the quality of the image is acceptable and results in resolution of each of the pills in the field of view. The dispensed quantity is a sufficient quantity in relation to the target or prescribed quantity. Specifically, a cluster 1212 of pills is still resolved and all are included in the count of the pills in the prescription product. In view (3), the quality of the image is acceptable and results in resolution of each of the pills in the field of view. The dispensed quantity is greater than the target or prescribed quantity. Specifically, pills that are touching a cluster 1214 are still resolved and all are included in the count of the pills in the prescription product. In contrast, in view (4), the image is rejected with an alert (e.g., warning) generated because there is a ghost shadow or image 1216 of a pill while the other pills in view are resolved and included in the count of the pills in the prescription.

FIG. 12D illustrates sample captured images of the prescription product in the field of view of the camera 439 of the imaging device 438 where a pill in the image is broken. Illustrated in the first image 1220 in view (1) are nine pills on a tray (not shown). One of the pills 1224 is broken while the other 8 pills 1222 are complete and intact. The second image 1226 in view (2) shows how multiple alert/warning conditions may be present in an image. In this case, there is a broken pill 1228 in the image, as well as stacked pills 1230 in the image. Either of these conditions detected in the image may cause the generation of an alert/warning.

FIG. 12E shows sample captured images of the prescription product in the field of view of the camera 439 of the imaging device 438 where co-mingled pills may be detected. The first image 1232 in view (1) shows a tray holding two distinct types of pills 1234, 1236. One set of pills 1234 is rectangular with rounded corners while a different second set of pills 1236 is round in shape. In this first image 1232 in view (1), the different pills 1236, 1234 are also of distinct colors. The recognition of co-mingled pills by the AI/ML components is made easier by the difference in color. The second image 1238 in view (2) also shows a tray with co-mingled pills. Again, the tray contains one set of pills 1242 that are rectangular with rounded corners as well as a different second set of pills 1240 that are round in shape. In this second image 1238, both sets of pills are of the same color (white), nonetheless, the AI/ML components are able to identify the co-mingled pill condition and generate an alert/warning.

FIG. 12F shows samples of captured images of the prescription product in the field of view of the camera 439 of the imaging device 438 from which blister packs or strips may be detected. The first image 1244 in view (1) shows a tray holding medication strips 1246a, 1246b, including prescription pills (not shown as they are on the bottom side of the strips 1246a, 1246b). One of the strips 1246a is a complete strip with 10 doses, while the other strip 1246b is a partial strip with only 2 doses. The AI/ML components are able to identify the strips whether complete or partial. The second image 1245 in view (2) shows a verification tray holding medication strips 1246c, 1246d, including prescription pills (not shown as they are on the bottom side of the strips 1246c, 1246d). Again, one of the strips 1246c is a complete strip with 10 doses, while the other strip 1246c is a partial strip with only 4 doses. The second image 1245 in view (2) also shows a colored box 1247 surrounding each medication strips 1246c, 1246d, respectively. The colored box 1247 includes a top label 1249 with the label indicating the image has been recognized by the AI/ML components as a blister pack followed by a confidence factor. As shown in the call out, the label 1249 includes the text “Blisterpack 0.90” indicating that the system 100 has a 90% confidence level that it is a blisterpack. It should be understood that the label may include various other information determined by the image analysis engine 410, for example, that medication strip 1246c has 10 doses while medication strip 1246d only has four doses.

FIG. 12G shows a sample captured image upon which an enhanced therapeutic classification check may be performed by the system 400. In some implementations, the image analysis engine 410 or the AI/ML components can create the composite image 1262 shown in FIG. 12G. FIG. 12G shows a composite image 1262 that includes a base image 1254 of a tray holding a plurality of pills. Overlaid on the base image 1254 are a stock image 1260 and a close-up image 1258 to form the composite image. The composite image 1262 may also include other text labels and information about the output or overlaid images generated by the image analysis engine 410 or the AI/ML components. For example, there is a first label indicating that stock image 1260 is a stock image of a pill based on National Drug Code (NDC) Directory. A second label indicates a percentage level of confidence that the AI/ML components have that pill in the image correctly and the likelihood it matches the stock image 1260. Additionally, one or more of the pills may be identified by a call out box 1256. The call out box 1256 specifies the group of pills used to generate the close-up image 1258. It should be understood that FIG. 12G is merely one example, and that the user interface generated by the system 400 may provide the information in the labels or the additional images forming the composite image 1262 in separate parts of the user interface not overlaid on the base image 1254.

FIG. 12H shows a sample of a captured image of the prescription product in the field of view of the camera 439 of the imaging device 438 from which the product may be determined, and certain portions enhanced. The image 1248 in FIG. 12H shows an image of a pill container having a label that is detected on the verification tray. The label includes identifying text 1250. This identifying text is captured and a close-up or enhanced image 1252 is provided. In some implementations, the image analysis engine 410 or the AI/ML components can provide the close-up image 1252 as an overlay on second image 1248 as shown in FIG. 12H, or alternatively, on the separate part of the display not shown. In some implementations, the image analysis engine 410 performs optical character recognition (OCR) on the close-up image 1252 as well.

FIG. 12I shows a sample of a captured image 1266 of a pill vial 1268 in the field of view of the camera 439 of the imaging device 438 on the verification tray. The product in the image is determined by the image analysis engine 410 and/or the AI/ML components as a pill vial 1268. The portion of the image used to identify the pill vial 1268 is specified by a colored box 1269 surrounding the pill vial 1268. The colored box 1269 also includes a label 1267 indicating the image 1266 has been recognized by the AI/ML components as a pill vial followed by a confidence factor. As shown in the call out, the label 1249 includes the text “AmberVial 0.63” indicating that the image analysis engine 410 has a 63% confidence level that it is an amber pill vial.

FIG. 12J shows a sample of a captured image 1270 of packs 1271 in the field of view of the camera 439 of the imaging device 438 on the verification tray. The product in the image 1270 is determined by the image analysis engine 410 and/or the AI/ML components as a pack 1271 with a label. The portion of the image used to identify the packs 1271 is specified by a colored box 1272 surrounding the packs 1271. The colored box 1272 also includes a label 1273 indicating the image has been recognized by the AI/ML components as packs 1271 followed by a confidence factor. As shown in the call out, the label 1273 includes the text “PacksLabeled 0.95” indicating that the image analysis engine 410 has a 95% confidence level that it is packs and has a label. It should be understood that in some implementations, the image analysis engine 410 performs optical character recognition (OCR) on the label in image 1270 and the label could include additional data for example information on the label or on the labeling of the pack 1271. This information could be provided in whole or part of label 1273.

FIG. 12K shows a sample of a captured image 1274 of a prescription box 1275 in the field of view of the camera 439 of the imaging device 438 on the verification tray. The product in the image 1274 is determined by the image analysis engine 410 and/or the AI/ML components as a prescription box 1275 with a label. The portion of the image used to identify the prescription box 1275 is specified by a colored box 1276 surrounding the prescription box 1275. The colored box 1276 also includes a label 1277 on its periphery indicating the image 1274 has been recognized by the AI/ML components as a prescription box 1275 followed by a confidence factor. As shown in the call out, the label 1277 includes the text “Box Labeled 0.91” indicating that the image analysis engine 410 has a 91% confidence level that it is a prescription box and has a prescription label. FIG. 12K also illustrates how the image analysis engine 410 can detect other items in overlapping areas of the colored box 1276. In this example, the image analysis engine 410 has also detected pill residue or a ghost pill with a confidence level of 27% as shown by a second colored box 1278. It should be noted that in any of FIGS. 12A to 12O, the image analysis engine 410 may detect multiple conditions on the verification tray simultaneously in addition to each item described in detail in each of FIGS. 12A to 12O as being identified, and this is merely one example.

FIG. 12L shows samples of captured images 1280, 1281 of the prescription product in the field of view of the camera 439 of the imaging device 438 from which stock pill bottles 1282a, 1282b, and 1282c, may be detected in the image of the verification tray. The first image 1280 in view shows a pair of stock pill bottles with no prescription labels, and only the standard labels with which the pill bottles are received by the pharmacy. The first image 1280 shows that the image analysis engine 410 is capable of recognizing multiple stock pill bottles on the verification tray. Referring now to the second image 1281 shown in FIG. 12L, another example of a stock pill bottle 1282c is shown. In this second example, the stock pill bottle 1282c also has a prescription label attached. The image analysis engine 410 analyzes the image 1281 and augments the image by providing a colored box 1283 around the portion of the image used to identify the stock bottle 1282c. Again, a label 1284 for this colored box 1283 including the item identified and a confidence factor. As shown in the call out, the label 1284 includes the text “Stock Bottle Labeled 0.86” indicating that the image analysis engine 410 has an 86% confidence level that it is a stock bottle with a prescription label in the image. In this example image 1281, the image 1281 may also contain additional information generated by the image analysis engine 410. A second less highlighted label may indicate that the image analysis engine 410 identified the stock bottle with only a 55% confidence score in the initial processing of the image by the image analysis engine 410. Similar to some of the other example images described above, image 1281 also illustrates that the image analysis engine 410 has also detected pill residue or a ghost pill with a confidence level of 78% as shown by a second colored box 1278 to the left of the box 1283.

FIG. 12M shows a sample of a captured image 1285 of pen 1286 in the field of view of the camera 439 of the imaging device 438 on the verification tray. The product in the image 1285 is determined by the image analysis engine 410 and/or the AI/ML components as a pen 1286 with a prescription label. The portion of the image used to identify the pen 1286 is specified by a colored box 1287 surrounding the pen 1286. The colored box 1287 also includes a label 1288 indicating the image has been recognized by the AI/ML components as a pen 1286 followed by a confidence factor. As shown in the call out, the label 1288 includes the text “Pen Labeled 0.53” indicating that the image analysis engine 410 has a 53% confidence level that it is a pen and has a prescription label. Again, it should be understood that in some implementations, the image analysis engine 410 performs optical character recognition (OCR) on the prescription label in image 1285 and the prescription label or the product label could include additional data for example information on the prescription label about the prescription, dosage, physician, or manufacturer on the labeling of the pen 1285. This information could be provided in whole or part to other parts of the system 400.

FIG. 12N shows a sample of captured images of pill residue or ghost pills 1278 in addition to the detection of other conditions 1222, 1228. For example, a first image 1290 shows pill residue 1278, broken pills 1228 and intact pills 122. The first image 1290 illustrates how the image analysis engine 410 is able to detect multiple conditions within the same image. In this case, the image analysis engine 410 identifies a pill residue 1278 condition, an intact pill condition 1222, and a broken pill 1228 condition. Additionally, the first image 1290 illustrates how each of the identified conditions can be labeled with different colors and with a bounding box around each area of the image that has the condition. In this example, a first color, green, of a bounding box indicates a pill residue 1278 condition. A second color, pink, of a bounding box indicates a broken pill 1228 condition. A third color, purple, of a bounding box indicates an intact pill 1222 condition. It should be understood that each of the bounding boxes may also include a label similar to that described above which indicates the condition that was detected as well as the confidence level of the detection and analysis. A second image 1291 is provided to illustrate that the image analysis engine 410 is operable on a variety of different types of pills regardless of size and shape. In the second image 1291, rather than having a cylindrical flat faced pill shape, the pills have an oblong beveled edge shape. The differences between the images 1290 and 1291 also illustrate that the image analysis engine 410 is capable of detecting any number of conditions. For example, in image 1290, there are three pill residue 1278 conditions while in the second image 1291, there are only two pill residue 1278 conditions.

FIG. 12O shows a graphical representation of a sample captured image 1292 showing other items detectable on the verification tray. In this example, the image analysis engine 410 is able to identify both a box 1293 and the contents of the box which are packs 1294. Again, as has been described above, each portion of the image that has been identified by the image analysis engine 410 will have a bounding box and a label indicating what was identified and the confidence level of the identification by the image analysis engine 410. The image of FIG. 12O also illustrates how the image analysis engine 410 is able to identify items within the image even though they extend beyond the bounds of the verification tray. Thus, the system 400 of the present disclosure is particularly advantageous because it is able to capture, analyze and identify various items within the image even though they may extend beyond the verification tray.

FIG. 12P shows one final graphic representation of a captured image 1295 in the field of view of the camera 439 of the imaging device 438 on the verification tray. Again, FIG. 12P illustrates how the image analysis engine 410 is still capable of identifying the item even though the item or its packaging extends beyond the bounds of the verification tray. In this example, the image analysis engine 410 is able to identify the product as a syringe as well as identifying that there are two syringes. While not shown, the image analysis engine 410 is also able to indicate the product identified and a confidence level associated with the identification. In some implementations, the system 400 can also provide feedback to the user to change the orientation and placement of the item on the verification tray. In this case, such instructions are provided to have the operator move or drag and drop the image that is captured by the system 400.

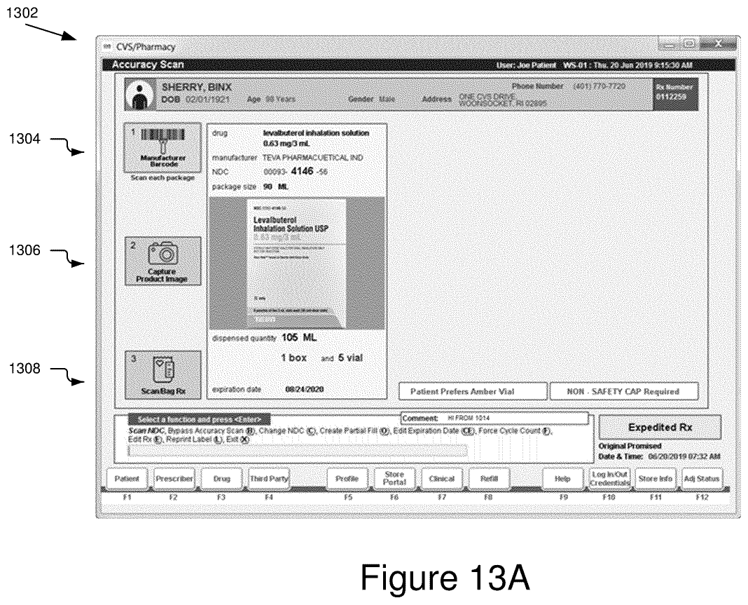

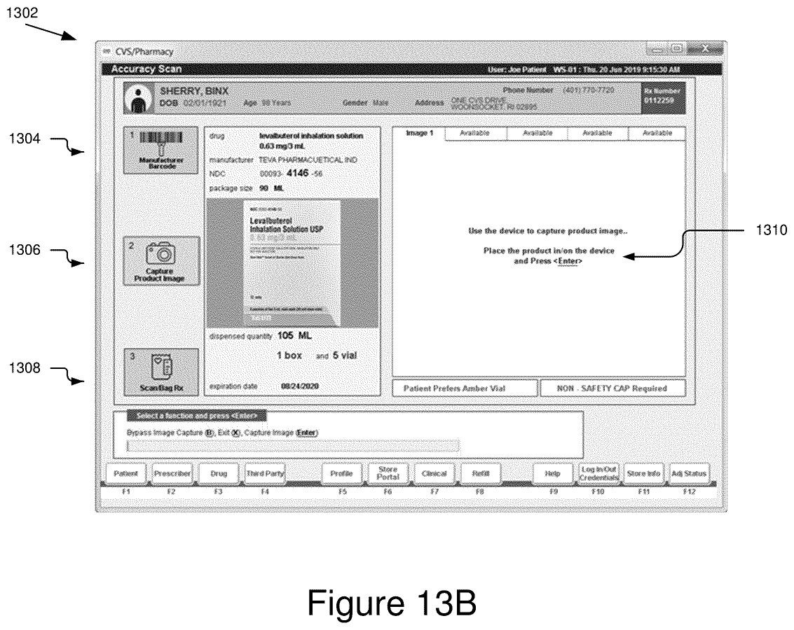

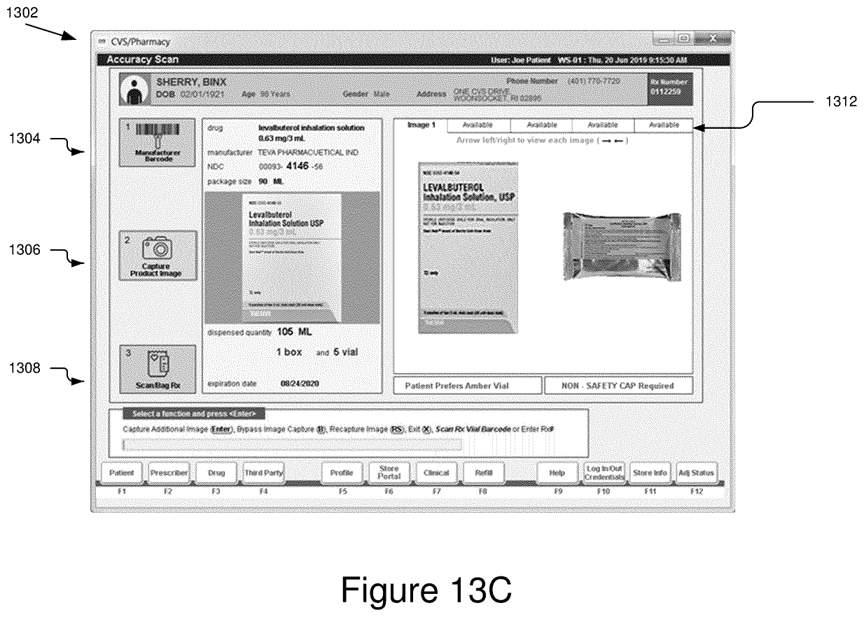

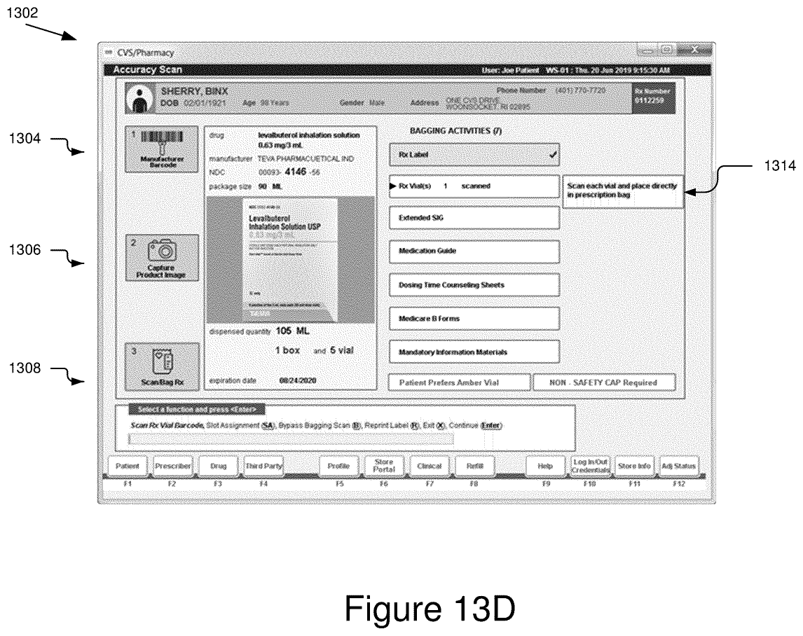

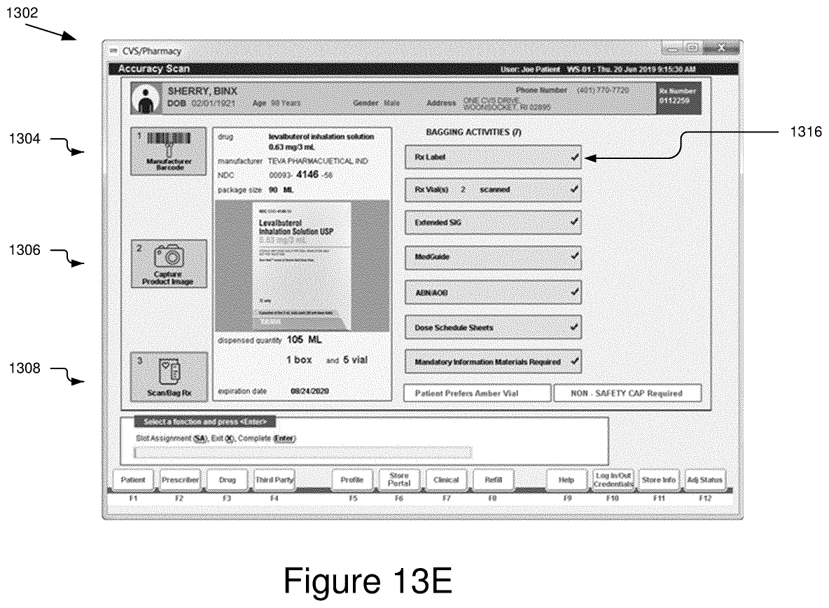

FIG. 13A shows an example user interface generated by a dispensing application 434. FIG. 13A shows an example starting page 1302 in the prescription fill process. After printing the prescription label and accompanying documents, the technician may be led through a series of interfaces configured by the workflow to successfully complete three steps to qualify the prescription to be virtually verified by a pharmacist using the images. The first step 1304 is to scan the barcode of each package to validate the right prescription product. The second step 1306 is to capture one or more images of the prescription product. The third step 1308 is to scan and bag the prescription product for pick-up. In FIG. 13A, the technician starts by performing a scan of z, NDC, expiration date, etc. to validate the prescription product in the received images.

After completing the appropriate product scans, the interface in the verification workflow shown in FIG. 13B shifts to the second step 1306 of capturing images of the prescription product using the imaging device. The capture image portion of the interface in FIG. 13B includes instructions 1310 for the technician to place the product in the imaging device to capture images. The technician may place the product in the imaging device and select ‘Enter’ option in the interface to start capturing one or more images of the product. In some implementations, the user will be able to view a livestream camera feed on-screen to help guide the camera to aim and focus on product placement.

As shown in the interface of FIG. 13C, the technician may capture more than one image and build an album of images for the pharmacist to review during virtual verification. In one specific implementation, the technician may capture 15 or more images. The interface displays each of the captured image in a separate tab 1312. The technician may also use menu options included in the interface, such as recapture image, bypass image capture, delete, and exit to manage the creation of the album of images.

After capturing the images of the prescription product, the interface in the workflow shown in FIG. 13D brings the technician to the third step of guided bagging process 1314 to complete the prescription fill. The interface in FIG. 13D includes a dynamic list of bagging activities that the technician has to complete for each prescription fill. Some of the activities relate to FDA/Medicare documents. Some of the other activities are for internal auditing of the pharmacy. The activities include but not limited to:
1—Scanning the prescription label;
2—Scanning and bagging the prescription vials/products in a prescription bag;
3—Scanning & attaching Extended SIG (directions);
4—Scanning & attaching Medication guide;
5—Scanning & attaching Medicare B forms;
6—Scanning & attaching Dosing Time Counseling Sheets; and
7—Confirming Mandatory Information Materials inclusion.

As each activity is completed, the interface shown in FIG. 13E displays information to allow the technician to visually check off 1316 each of the activities by progressing through the workflow. Once the list of bagging activities is complete, the technician may complete his or her workflow and physically transfer the prescription package or bag to the waiting bin for hold. The prescription package cannot be sold to the customer without the pharmacist completing the verification workflow.

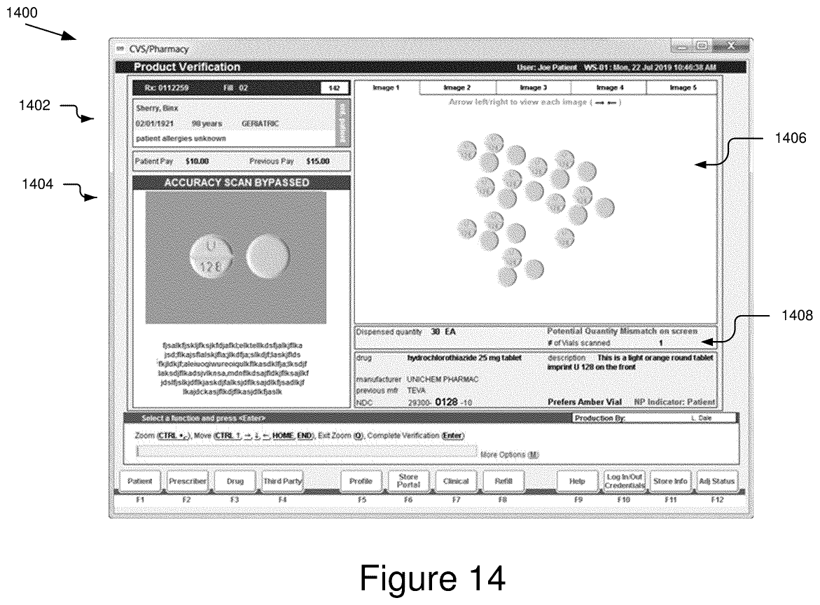

FIG. 14 shows an example interface 1400 in the virtual verification of the prescription product. The interface 1400 in FIG. 14 highlights all relevant information for the pharmacist to review and verify. For example, the interface may include patient details 1402 including name, age, classification, and allergies. The interface may highlight any step 1404 in the prescription fill process that was bypassed or done incorrectly by the technician. The pharmacist may review the reason for the bypassed step if provided by the technician. The interface may allow the pharmacist to review each of the images 1406 analyzed and returned by the image analysis engine. The pharmacist may only complete verification after reviewing each image in the album. The image analysis engine may flag one or more images for any detected anomalies and provide an appropriate reasoning for the flagging. In the example of FIG. 14, the interface highlights 1408 that there is a potential mismatch between the dispensed quantity and the actual count of the pills in the captured image. In another example, the interface may identify the type of pills in the captured image and highlight presence of an unrelated pill mixed in with the prescribed pills. In some implementations, the interface may allow the pharmacist to access the stock images of the imaged pills from the enterprise pharmacy data system to perform a comparison. If the comparison check passes, the pharmacist may complete virtual verification and approve the prescription fill for customer pick-up. If the comparison check fails, the pharmacist may reject the prescription fill and provide comment indicating the reason for rejection. The prescription may be refilled by the technician or the pharmacist depending on the pharmacy workflow.

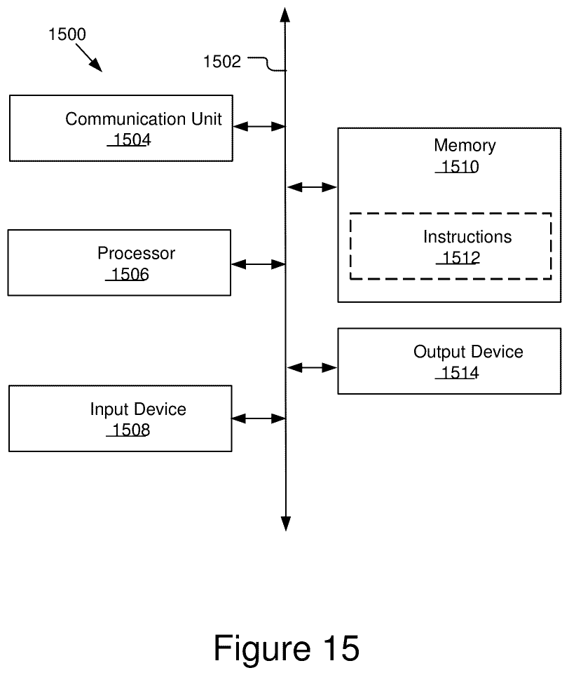

FIG. 15 is a block diagram of an example computing device 1500, which may represent the computer architecture of a pharmacy computing device and servers hosting enterprise pharmacy data systems and/or the image analysis engine. As depicted, the computing device 1500 may include a processor 1506, a memory 1510, a communication unit 1504, an input device 1508, and an output device 1514, which may be communicatively coupled by a bus 1502. The computing device 1500 depicted in FIG. 15 is provided by way of example and it should be understood that it may take other forms and include additional or fewer components without departing from the scope of the present disclosure. For instance, various components of the computing device 1500 may be coupled for communication using a variety of communication protocols and/or technologies including, for instance, communication buses, software communication mechanisms, computer networks, etc. While not shown, the computing device 1500 may include various operating systems, sensors, additional processors, and other physical configurations. The processor 1506, memory 1510, communication unit 1504, etc., are representative of one or more of these components. The processor 1506 may execute software instructions by performing various input, logical, and/or mathematical operations. The processor 1506 may have various computing architectures to process data signals (e.g., CISC, RISC, etc.).

The processor 1506 may be physical and/or virtual and may include a single core or plurality of processing units and/or cores. In some implementations, the processor 1506 may be coupled to the memory 1510 via the bus 1502 to access data and instructions therefrom and store data therein. The bus 1502 may couple the processor 1506 to the other components of the computing device 1500 including, for example, the memory 1510, the communication unit 1504, the input device 1508, and the output device 1514. The memory 1510 may store and provide access to data to the other components of the computing device 1500. The memory 1510 may be included in a single computing device or a plurality of computing devices. In some implementations, the memory 1510 may store instructions and/or data that may be executed by the processor 1506. For example, the memory 1510 may store one or more of the image analysis engines, dispensing application, workflow system, pharmacy services, verification workflow etc. and their respective components, depending on the configuration. The memory 1510 is also capable of storing other instructions and data, including, for example, an operating system, hardware drivers, other software applications, databases, etc. The memory 1510 may be coupled to the bus 1502 for communication with the processor 1506 and the other components of computing device 1500.

The memory 1510 may include a non-transitory computer-usable (e.g., readable, writeable, etc.) medium, which can be any non-transitory apparatus or device that can contain, store, communicate, propagate or transport instructions 1512, data, computer programs, software, code, routines, etc., for processing by or in connection with the processor 1506. In some implementations, the memory 1510 may include one or more of volatile memory and non-volatile memory (e.g., RAM, ROM, hard disk, optical disk, etc.). It should be understood that the memory 1510 may be a single device or may include multiple types of devices and configurations.

The bus 1502 can include a communication bus for transferring data between components of a computing device or between computing devices, a network bus system including the network 1502 or portions thereof, a processor mesh, a combination thereof, etc. In some implementations, the various components of the computing device 1500 cooperate and communicate via a communication mechanism included in or implemented in association with the bus 1502. In some implementations, bus 1502 may be a software communication mechanism including and/or facilitating, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, communication between components of computing device 1500 via bus 1502 may be secure (e.g., SSH, HTTPS, etc.).

The communication unit 1504 may include one or more interface devices (I/F) for wired and/or wireless connectivity among the components of the computing device 1500. For instance, the communication unit 1504 may include, but is not limited to, various types of known connectivity and interface options. The communication unit 1504 may be coupled to the other components of the computing device 1500 via the bus 1502. The communication unit 1504 can provide other connections to the network and to other entities of the system in FIG. 4 using various standard communication protocols.

The input device 1508 may include any device for inputting information into the computing device 1500. In some implementations, the input device 1508 may include one or more peripheral devices. For example, the input device 1508 may include a keyboard, a pointing device, microphone, an image/video capture device (e.g., camera), a touchscreen display integrated with the output device 1514, etc. The output device 1514 may be any device capable of outputting information from the computing device 1500. The output device 1514 may include one or more of a display (LCD, OLED, etc.), a printer, a 3D printer, a haptic device, audio reproduction device, touch-screen display, a remote computing device, etc. In some implementations, the output device 1514 is a display which may display electronic images and data output by a processor, such as processor 1506 of the computing device 1500 for presentation to a user.

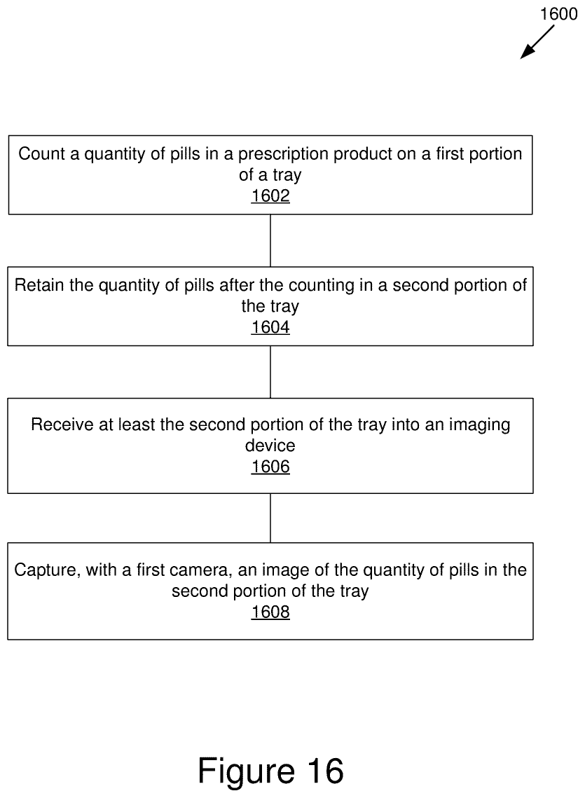

FIG. 16 is a flowchart 1600 for configuring a system for facilitating virtual verification of dispensed prescription product.

In a block 1602, the quantity of pills in a prescription product is counted on the first portion of a tray. In one example, the quantity of pills may be retrieved from a bulk container. In another example, the quantity of pills may be retrieved by an automated process. In other examples, the quantity of pills may be retrieved and counted by a technician.

In a block 1604, the quantity of pills may be retained after the counting in a second portion of the tray. In one example, the second portion of the tray is a lower portion of a counting tray, such as a CAIT described herein. In another example, the second portion of the tray biases the quantity of pills toward a field of view of the first camera.

In a block 1606, at least the second portion of the tray is received in an imaging device. In one example, at least a portion of the second portion is aligned within the field of view of the first camera of the imaging device. In another example, the second portion of the tray is positioned opposite the first camera and is positioned in the field of view of the first camera. In other examples, the second portion of the tray is illuminated when the second portion of the tray is received in the imaging device.

In a block 1608, the first camera captures an image of the quantity of pills in the second portion of the tray. In one example, the images may be stored and made available for access and verification by a pharmacist.

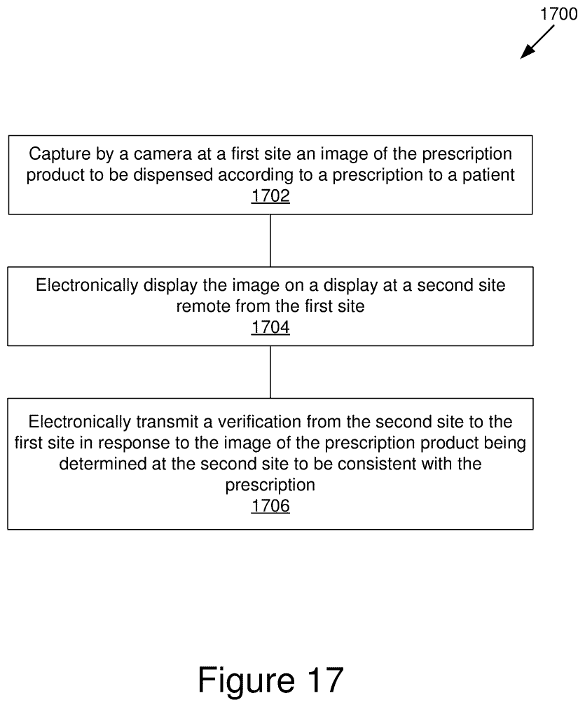

FIG. 17 is a flowchart 1700 for a method for virtual verification of dispensed prescription product.

In a block 1702, an image of the prescription product to be dispensed according to a prescription to a patient is captured by a camera at the first site. In one example, the camera may be configured with an imaging device as described herein. In another example, a quality of the image is determined based on at least one of a presence of expected features and absence of unexpected features of the prescription product in the image, and another image is recaptured to replace the image in response to the quality being unacceptable. In other examples, the quality of the image at the first site is determined based on a brightness of the image, and another image is recaptured to replace the image in response to the quality being unacceptable. In other examples, an electronically determined quantity of pills from the image is electronically counted at the first site. In other examples, a confidence factor is electronically generated at the first site based on the electronically determined quantity of pills. In still other examples, each of the electronically determined quantity of pills is annotated in response to completion of the electronically counting each of the electronically determined quantity of pills in the prescription product. In yet further examples, ones of the prescription product that are unable to be electronically counted are differently annotated. In further examples, the electronically determined quantity of pills and the confidence factor of the electronically determined quantity of pills is associated with the image of the prescription product.

In a block 1704, the image is electronically displayed on a display at a second site remote or physically distanced/separated from the first site. In one example, the second site includes a pharmacist for verifying the dispensed prescription product.

In a block 1706, a verification is electronically transmitted from the second site to the first site in response to the image of the prescription product being determined at the second site to be consistent with the prescription. In one example, the first site and the second site are spatially distant. In another example, the first site and the second site are collocated but separately manned. In yet another example, the prescription product is packaged for sale at the first site prior to receiving the verification from the second site.

FIG. 18 shows an example high-level architecture diagram including the image analysis engine 410b according to some implementations. In this implementation, the image analysis engine 410b comprises a web server gateway interface (WSGI) 1802, a data quality classifier 1804, a brightness classifier 1806, a pill detector 1808, an optical character recognition (OCR) module 1810, a co-mingling detector 1812, other condition detector(s) 1814, an image annotator 1816, and an image storer 1818. These components are coupled for communication and interaction with each other, the proxy and web server proxy 906, and the image database 902, as depicted. It should be understood that the image analysis engine 410b may also include other components not shown such as those described above with reference to the image analysis engine 410a of FIG. 9A.

The web server gateway interface (WSGI) 1802 may be steps, processes, functionalities, software executable by a processor, or a device including routines for communicating and interacting with the proxy server 906 and the image database 902. The web server gateway interface 1802 is coupled to receive control signals and commands from the proxy and web server 906. The web server gateway interface 1802 is also coupled to receive images from the proxy and web server 906, and/or retrieve and receive images from the image database 902. The web gateway interface 1802 processes commands, control signals, and/or images received and sends them to a corresponding component 1804-1818 of the image analysis engine 410b for further processing. For example, the proxy and web server 906 may provide an image and a command for processing the image to detect any one or more conditions of the prescription product in the image. The web gateway interface 1802 also sends images, processing results, and requests for additional information to the proxy and web server 906 to enable the functionality that has been described above.

The data quality classifier 1804 may be steps, processes, functionalities, software executable by a processor, or a device including routines for processing images received by the image analysis engine 410b to verify that the image received is of sufficient quality that the other components 1806, 1808, 1810, 1812, 1814, 1816 and 1818 of the image analysis engine 410b are able to process the image. In some implementations, the data quality classifier 1804 performs an initial processing of any received image to ensure that it is of us of sufficient quality that the other components 1806, 1808, 1810, 1812, 1814, 1816 and 1818 of the image analysis engine 410b can perform their function. In some implementations, the images are passed in parallel to the data quality classifier 1804 and the other components 1806, 1808, 1810, 1812, 1814, 1816 and 1818 of the image analysis engine 410b. In such an example, the output of the data quality classifier 1804 is also provided to the other components 1806, 1808, 1810, 1812, 1814, 1816 and 1818. In some implementations, the image must satisfy the quality check performed by the data quality classifier 1804 before the image is sent to other components 1806, 1808, 1810, 1812, 1814, 1816 and 1818 of the image analysis engine 410b. In some implementations, the data quality classifier 1804 is implemented using a convolutional neural network with several layers. For example, the data quality classifier 1804 may be a RESNET50 Model with 50 layers, the top layer removed, pre-trained weights, and custom layers including a flatten layer, a dense layer, a batch normalization layer, a dropout layer, and a dense layer. It should be understood that other AI/ML constructs, for example, those described above with reference to the AI/ML package 908 can be used in place of the convolutional neural network in other implementations.

The brightness classifier 1806 may be steps, processes, functionalities, software executable by a processor, or a device including routines for determining whether the image has any lighting issues. For example, the brightness classifier 1806 may determine if the image is too bright, too dim, has portions shadowed or shaded, etc. The brightness classifier 1806 is coupled to receive images for analysis, for example, from the Web server gateway interface 1802 or from the data quality classifier 1804. The brightness classifier 1806 generates a signal to indicate whether the image has any lighting issues or not. The output of the brightness classifier 1806 can be provided to any of the components 1802, 1804, 1808, 1810, 1812, 1814, 1816 and 1818 of the image analysis engine 410b. In some implementations, the brightness classifier 1806 implements a random forest algorithm. For example, the brightness classifier 1806 may be a random forest algorithm with the following attributes: an Input Image Shape of 1024 pixels; Output Classes of alert bright, alert dim, gamma bright, gamma dim; a Loss Function of entropy; Training Parameters: estimators of 40 and max depth of 25. It should be understood that other AI/ML constructs, for example, those described above with reference to the AI/ML package 908 can be used in place of the random forest algorithm in other implementations.

The pill detector 1808 may be steps, processes, functionalities, software executable by a processor, or a device including routines for detecting and counting prescription products in an image. In particular, the pill detector 1808 may detect the type and number of pills in an image. The pill detector 1808 is coupled to receive an input image from the Web server gateway interface 1802, the data quality classifier 1804, or the brightness classifier 1806. The pill detector 1808 receives an image and processes the image using computer vision techniques to output the type of pill detector as well as the number of pills detected. In some implementations, the pill detector 1808 is a real-time object detection model, for example, You Only Look Once (YOLO) model. In one implementation, the pill detector 1808 is YOLOV4 with the following parameters: Input Image Shape: 608×608×3; Output_Image_ Classes: pill, rectangle; Training Hyper Parameters: Class threshold: 0.7, Intersection over union threshold: 0.7, Non Max Suppression threshold: 0.45, and Object threshold: 0.1; Training Framework: Darknet; Deployment Framework: OpenVINO; and Deployment Model Optimization: INT8. In some implementations, the output of the pill detector 1808 is provided for further analysis to determine whether the pill count matches the prescription and is used to generate a warning signal if the pill count is above or below the prescription. The pill detector 1808 can also be used to send information about the type of pill detected and send a warning signal if the type of pill detected does not match the prescription. In some implementations, the pill detector 1808 cooperates with the image annotator 1816 to detect and match the pill type to an NDC code or an image from the image database 902 corresponding to the NDC code. It should be understood that other AI/ML constructs, for example, those described above with reference to the AI/ML package 908 can be used in place of the YOLO model in other implementations.

The optical character recognition (OCR) module 1810 may be steps, processes, functionalities, software executable by a processor, or a device including routines for performing optical character recognition on the image provided and performing further analysis of the recognized text from the image. In particular, the OCR module 1810 may recognize any text on a pill or prescription product or any text on packaging for the prescription products. The OCR module 1810 is coupled to receive an input image from the Web server gateway interface 1802, the data quality classifier 1804, or the brightness classifier 1806. The OCR module 1810 performs optical character recognition to detect any text or meta data in the image. The OCR module 1810 performs optical character recognition on the image to generate text. The generated text is provided to the image annotator 1816 so that the information can be associated and/or stored with the image. For example, the annotated image is stored in the image database 902. In other implementations, the annotated image is provided for further analysis and warnings. For example, OCR may be used to detect non-pill objects in the image as shown in FIG. 12B, detect complete or incomplete medication packaging, or detect NDC codes as shown in FIG. 12F. For example, images with these conditions are shown in FIG. 12F. If any of these conditions are detected by the OCR module 1810, the OCR module 1810 can generate and send a signal to other components of the image analysis engine 410b for delivery to other parts of the system.

The co-mingling detector 1812 may be steps, processes, functionalities, software executable by a processor, or a device including routines for detecting whether the image contains co-mingled types of prescription products. In particular, the co-mingling detector 1812 determines whether the image contains pills of two or more distinct types. The co-mingling detector 1812 is coupled to receive an input image from the Web server gateway interface 1802, the data quality classifier 1804, or the brightness classifier 1806. The co-mingling detector 1812 receives an image and processes the image using computer vision techniques to output the types of pills detected in the image. An example of an image of co-mingled pills is shown in FIG. 12E. The co-mingling detector 1812 determines whether the types of pills detected in the image are different (two or more types) or whether they are all the same. If two or more distinct types of pills are detected in the image, the co-mingling detector 1812 generates and sends a warning signal. In some implementations, the co-mingling detector 1812 is a real-time object detection model. It should be understood that other AI/ML constructs, for example, those described above with reference to the AI/ML package 908 can be used in place of the object detection model in other implementations.

The other condition detector(s) 1814 may be steps, processes, functionalities, software executable by a processor, or a device including routines for detecting other conditions in a tray or a prescription package in the image. The other condition detector 1814 is coupled to receive an input image from the Web server gateway interface 1802, the data quality classifier 1804, or the brightness classifier 1806. The other condition detector 1814 may detect one other condition, or it may detect a plurality of different conditions. In alternate implementations, there may be one or more other condition detectors 1814. The other condition detector 1814 may detect any condition in the image, including but not limited to, a non-pill object in the image, stacked pills in the image, a pill cut in the image, a focus check on the image, a check for pill residue, a broken pill, a watermark, a tamper condition, a blurred condition, pill strips, etc. A non-pill object in the image is signaled by the other condition detector 1814 if the image includes a non-pill object such as a prescription container as shown in FIG. 12B (1). A stacked pills in the image is signaled by the other condition detector 1814 if the image includes a pill or prescription product overlapping another as shown, for example, in FIG. 12B (4) or FIG. 12D (2). A pill cut in the image is signaled by the other condition detector 1814 if the image includes any pill or prescription product on the edge of the image with a portion of the pill line outside the boundaries of an image, for example, as shown in FIG. 12B (2). A focus check is signaled by the other condition detector 1814 to determine if the image is in focus or not. A pill residue warning is generated by the other condition detector 1814 if the image contains pill residue, for example, as depicted in FIG. 12C (4). In some implementations, the other condition detector 1814 may be a pill residue filter applying an algorithm that checks for the area and color density of each detected pill. A broken pill condition signal is generated by the other condition detector 1814 if the image includes a broken pill, for example, as depicted in FIG. 12d (1). In some implementations, the other condition detector 1814 may also check for a therapeutic classification and confirm that any prescription product identified in the image has the correct therapeutic classification. It should be understood that other AI/ML constructs, for example, those described above with reference to the AI/ML package 908 may be used in place of the other condition detector(s) 1814 in various combinations of different AI/ML types in other implementations.

The image annotator 1816 may be steps, processes, functionalities, software executable by a processor, or a device including routines for receiving an input image and annotating the input image with the information determined by the image analysis engine 410b. The image annotator 1816 uses the analysis of the AI models and determines an area or portion of the image to annotate. In some implementations, the image annotator 1816 can annotate the image by adding other data, additional images, or recognition results. An example of an annotated image is shown in FIG. 12G and includes annotations such as a stock image from the NDC, a determination of whether there is a match, an expanded image of a portion of the original image, and any other annotated information generated by the image analysis engine 410b or any one of these components 1802, 1804, 1806, 1808, 1810, 1812, 1814, and 1818. In some implementations, the image annotator 1816 adds a watermark or other security feature to the annotated image to ensure it is tamperproof. The image annotator 1816 is coupled to receive an image from the Web server gateway interface 1802, the data quality classifier 1804, or the brightness classifier 1806. The image annotator 1816 may provide the annotated image to the image store 1818 for storage in the image database 902 or to the Web server gateway interface 1802 for transmission to the proxy and Web server 906 and other system components.

The image storer 1818 may be steps, processes, functionalities, software executable by a processor, or a device including routines for storing any images or results in the image database 902. The image storer 1818 is coupled to the other components 1802, 1804, 1806, 1808, 1810, 1812, 1814, and 1816 of the image analysis engine 410b to receive images and information. The image storer 1818 has an output coupled to the image database 902 or to the Web server gateway interface 1802 for delivery of images for storage therein or at other storage locations in the system 400.

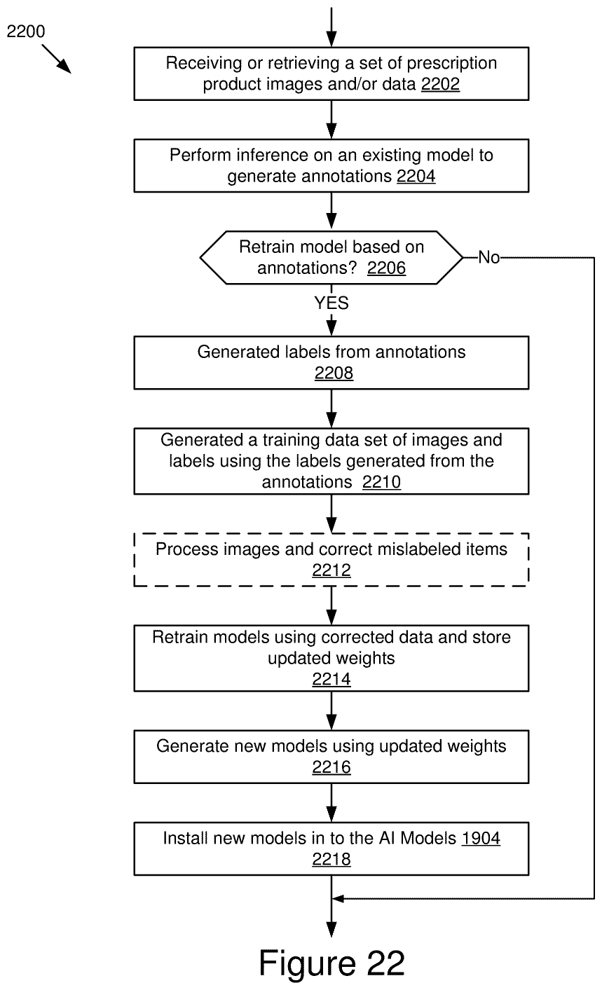

In some implementations, the components 1802, 1804, 1806, 1808, 1810, 1812, 1814, 1816, and 1818 of the image analysis engine 410b may have combined functionality of the other components and may detect more than one prescription product condition even though for many of the above components only a single condition is described. For example, the data quality classifier 1804 or the brightness classifier 1806 may also analyze the image for a presence of non-pill objects (e.g., blaster strips, pill bottles), stacked prescription products, image focus, pill residue, or water marking. In some implementations, certain components 1802, 1804, 1806, 1808, 1810, 1812, 1814, 1816, and 1818 of the image analysis engine 410b may output a bypass signal so that a set of one or more components 1802, 1804, 1806, 1808, 1810, 1812, 1814, 1816, and 1818 process the image while others do not to improve the computational efficiency of the image analysis engine 410b. For example, in some implementations, one or more override signals may be set to bypass processing by many of the components, and only perform pill detection and count functionality to reduce the latency on computation. Similarly, in some implementations, the image analysis engine 410b generates and sends a notification signal to the operator if the data quality check has failed, the brightness check has failed, a pill cut detected, or any other condition requiring a new image, so that the user can make changes on the image capture side to improve capture quality, which in turn will improve the performance of the machine learning models. In some implementations, the machine learning components of the image analysis engine 410b are subject to an automated retraining pipeline that is set up for retraining on the existing models to keep the models resistant to the input conditions. An example of this process is described below with reference to FIG. 22.

FIG. 19 shows an example high level architecture diagram of the image analysis engine 410c according to another implementation and depicting the AI data sets, models and training. In this implementation, the image analysis engine 410c comprises a data preparation module 1902, artificial intelligence (AI) models 1904, and the model trainer 1906. Although not shown in FIG. 19, the image analysis engine 410c may also include other components as described above with reference to FIGS. 9a and 18 for receiving commands and images and storing data and images. These components 1902, 1904, 1906 are coupled for communication and interaction with each other, the proxy and web server proxy 906, and the image database 902.

As depicted in FIG. 19, the data preparation module 1902 includes a data collection module 1910, an image processing module 1912, and a data annotation module 1914. The data collection module 1910 may be steps, processes, functionalities, software executable by a processor, or a device including routines for receiving commands, metadata, and images for processing by the image analysis engine 410c. The data collection module 1910 receives images and data for creating and training the AI models 1904. The data collection module 1910 also receives images for processing and evaluation by the AI models 1904. The data collection module 1910 is coupled to provide the training images to the model trainer 1906 and provide images for evaluation to the image processing module 1912. The data collection module 1910 also collects and receives data from other components and provides them to the various components of the image analysis engine 410c. The image processing module 1912 may be steps, processes, functionalities, software executable by a processor, or a device including routines for receiving commands, data, and images, and processing them using the AI models 1904. The image processing module 1912 receives an image and command from the data collection module 1910. The image processing module 1912 identifies which AI models 1904 should process the image and/or data based on the received commands and/or data. Responsive to the commands and/or data, the image processing module 1912 sends the image for processing to the appropriate AI models 1904. The image processing module 1912 receives the results from the processing of the image and/or data by the AI models 1904. Once the image and data have been processed, the image processing module 1912 outputs the results from the data preparation module 1902 to other components of the system 400 for storage, processing, or signaling. In some implementations, the image processing module 1912 sends the image and results to the data annotation module 1914. The data annotation module 1914 may be steps, processes, functionalities, software executable by a processor, or a device including routines for receiving results in an image and generating an annotated image. Example annotations have been shown and described above with reference to FIG. 12F and 12G. The annotated image is output by the data annotation module 1914 and sent to the image processing module 1912 for further processing or output to other components of the system 400.

In some implementations, the AI models 1904 include an object detection module 1916, a co-mingling module 1918, and an OCR module 1920. The architecture shown in FIG. 19 is merely one example of an architecture for organization of the AI models 1904. It should be understood that various other organizations of the AI models 1904 may also be used. Moreover, the AI models listed in the architecture are merely one example of different AI models 1904 that may be included in the architecture. It should be understood that some AI models 1904 may be removed, additional AI models for other conditions may be added, or the existing AI models may be replaced by models that detect two or more conditions identified. The object detection module 1916 includes one or more AI models for detecting the presence of a prescription product, e.g., pills. In this example, the object detection module 1916 includes a pill detection and counting model 1922, a broken pill detection model 1924, a pill residue detection model 1926, and a pill strips and non-pill detection model 1928. The function and specific AI technology used for these models has been described above with reference to FIG. 18 so that description will not be repeated. The pill detector 1808 may implement or use the pill detection and counting model 1922. The other condition detectors 1814 may implement or use the broken pill detection model 1924, the pill residue detection model 1926, and the pill strips & non-pill detection model 1928. The co-mingling module 1918 includes one or more AI models, for example a drug image check model 1930 and a co-mingling detection model 1932. The co-mingling detector 1812 may implement or use the drug image check model 1930 and the co-mingling detection model 1932. The OCR module 1810 and its structure and functionality have been described above with reference to FIG. 18.

The model trainer 1906 includes a model selector 1940, a training module 1942, a model evaluator 1944 and a parameter tuner 1946. The model trainer 1906 is coupled to provide AI and/or ML models to the AI model 1904. The model trainer 1906 is also coupled to the data preparation module 1902 as has been described above to receive training data, models, model parameters, and other information necessary to generate and train the AI models 904.

The model selector 1940 may be steps, processes, functionalities, software executable by a processor, or a device including routines for selecting a specific type of artificial intelligence or machine learning model to be used for the detection, identification, or other functions that the model will perform. In some implementations, the model selector 1940 chooses different types of AI/ML technology based on computational efficiency, accuracy, and input data type. The model selector 1940 receives images, data, commands, and parameters from the data preparation module 1902. The model selector 1940 uses the information received from the data preparation module 1902 to generate one or more models that eventually become the AI models 1904.

The training module 1942 may be steps, processes, functionalities, software executable by a processor, or a device including routines for training one or more AI models. The training module 1942 is coupled to receive a base model from the model selector 1940 with preset initial parameters. The training module 1942 also receives training data from the data preparation module 1902. The training data can include both positive training data with the examples of a correct identification, detection, or output and negative training data with incorrect identification, detection, or output. The training module 1942 may use supervised learning, semi-supervised learning, or unsupervised learning depending on the type of model that was provided by the model selector 1940. The training module 1942 may also adaptively retrain any one of the AI models 1904 at any time selected, at preset intervals, or when the accuracy of the AI model performance is found to satisfy or not satisfy a quality threshold. The training module 1942 is coupled to provide an AI model during training to the model evaluator 1944 and the parameter tuner 1946.

The model evaluator 1944 may be steps, processes, functionalities, software executable by a processor, or a device including routines for determining whether an AI model's performance satisfies a performance threshold. For example, for many of the AI models 1904 an accuracy greater than 90% may be required. In some instances, accuracy greater than 95% may be required. The model evaluator 1944 monitors the generation and training of the AI model by the training module 1942. The model evaluator 1944 reviews the output of the model during training to indicate when the model's accuracy satisfies a predefined threshold and is ready for use. The model evaluator 1944 is coupled to the training model 1942 to monitor its operation and is coupled to the parameter tuner 1946 to provide information about the model's performance and accuracy.

The parameter tuner 1946 may be steps, processes, functionalities, software executable by a processor, or a device including routines for modifying one or more parameters of the AI model during training. The parameter tuner 1946 is coupled to the training module 1942 to receive parameters values for the AI model and to modify them in response to information from the model evaluator 1944. The parameter tuner 1946 receives performance evaluation information from the model evaluator 1944. The parameter tuner 1946 uses the information from the model evaluator 1944 to selectively modify different parameters of the AI model until its performance satisfies a predetermined threshold. In some implementations, the parameter tuner 1946 receives initial parameters for training the model based upon the type of AI model that has been trained.

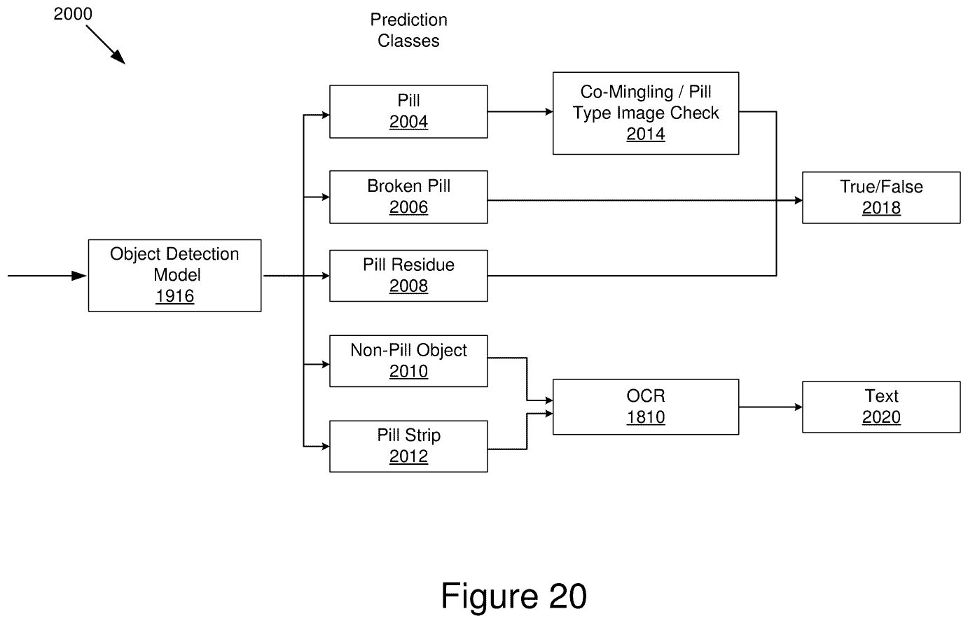

Referring now to FIG. 20, an example process flow 2000 for the AI processing of images in accordance with some implementations will be described. The process 2000 begins with the object detection module 1916 receiving an image to be processed. The object detection module 1916 provides the image to a plurality of prediction classes. While FIG. 20 shows the processing in parallel, the processing can be done serially for each AI model. One AI model 2004 receives the image and determines whether image contains one or more pills. If so, the image is provided to a second AI model 2014 to determine whether the image contains any co-mingled pills and also to perform a pill type image check. For example, the AI model 2014 may use images from an image source or image database.

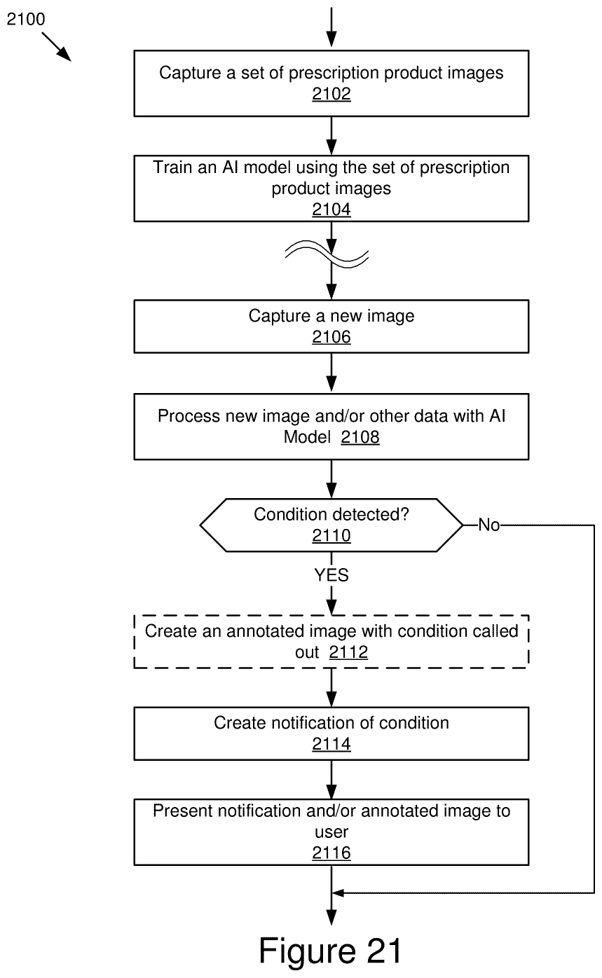

FIG. 21 is a flowchart for a method 2100 for virtual verification of a dispensed prescription product that uses artificial intelligence. The method 2100 begins by capturing 2102 a set of prescription product images. While the present disclosure is described in the context of pills as the prescription product, it should be understood that the present disclosure may also be applied to other forms of prescription products in addition to pills. The set of prescription product images may also be annotated, labeled, or grouped for training and generation of an ML/AI model. Next, the method 2100 trains 2104 an AI model using the set of prescription product images. It should be understood that steps 2102 and 2104 can be performed at an initialization phase which can be separate from the remaining steps of the method 2100. Once the AI model has been trained 2104, it can be used to process and detect prescription product conditions in images. The process for detecting pill conditions in images begins by capturing 2106 a new image and/or other data. Then the method 2100 continues by processing 2108 the new image and/or other data with the AI model. The AI model generates an output. The method 2100 determines 2110 whether a condition was detected based on the output. If not, the method 2100 proceeds to after block 2116. If a condition was detected in block 2110, the method 2100 proceeds to create 2112 an annotated image with the condition called out. It should be understood that block 2112 is optional, and therefore, shown with dashed lines in FIG. 21. The annotation of the image may be any one or more of those annotation types described above with reference to and shown in FIGS. 12F and 12G. Next, the method 2100 creates 2114 a notification of the condition detected by the AI model. The method 2100 continues by sending or presenting 2116 the notification to other parts of the system 400 or to the user. In some implementations, a user interface is updated and includes the annotated image generated in block 2112. In other implementations, a warning signal is generated and/or presented 2116 to the user. It should be understood that the notification of a condition may be used by various other components of the system as a triggering signal to take a variety of other actions.

Referring now to FIG. 22, a method 2200 for automated retraining an artificial intelligence model of an image analysis engine 410 is described. The method 2200 begins by receiving or retrieving 2202 a set of images and data to be used for retraining. In some implementations, the images may be of prescription products, specifically pills, and the data may be prescription scripts. The method 2200 continues by performing inference 2204 on an existing model to generate retraining annotations. In some implementations, the inference is performed with OpenVino models. Next, the method 2200 determines 2206 whether the model needs to be retrained based on the retraining annotations. If not, the method 2200 continues after block 2218. On the other hand, if the model needs retraining, the method 2200 continues to block 2208 to generate labels from the retraining annotations. In some implementations, the method 2200 converts the retraining annotations to Pascal VOC (visual object classification) format. Next, the method 2200 generates 2210 a training data set of images and labels using the labels generated from the retraining annotations in block 2208. In some implementations, a labeling graphical user interface (GUI) tool can be used to set the image and the extensible markup language (XML) directories for this block. The method 2200 continues by processing the training data set of images and labels, and correcting 2212 mislabeled items. In some implementations, this requires that a data scientist manually review the images and correct mislabeled items. This block 2212 is shown with dashed lines indicating that is optional, but if performed, the accuracy of the AI models will be improved. The method 2200 continues by using the corrected data from block 2212 to retrain 2214 models and store updated weights. In some implementations, the models may be retrained 2214 using a neural network such as Darknet. Next, the method 2200 generates 2216 new models using the newly trained models and updated weights from block 2214. Next the method 2200 installs the new models generated in block 2216 to update the AI models 1904.

While the examples provided have been in the context of a retail pharmacy, other applications of the described systems and methods are also possible. For example, workstation allocation and related task management could be applied to retail store (or pharmacy “front store”) operations or retail clinic operations. Other applications may include mail order pharmacies, long term care pharmacies, etc.

While at least one example implementation has been presented in the foregoing detailed description of the technology, it should be appreciated that a vast number of variations may exist. It should also be appreciated that an exemplary implementation or exemplary implementations are examples, and are not intended to limit the scope, applicability, or configuration of the technology in any way. Rather, the foregoing detailed description will provide those skilled in the art with a convenient road map for implementing an example implementation of the technology, it being understood that various modifications may be made in a function and/or arrangement of elements described in an exemplary implementation without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware implementation, an entirely software implementation (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user's computing device, partly on a user's computing device, as a stand-alone software package, partly on a user's computing device and partly on a remote computing device, or entirely on the remote computing device or a server. In the latter scenario, a remote computing device may be connected to a user's computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general-purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of the order noted in the figures. For example, two blocks shown in succession may in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

What is claimed is:

1. A computer-implemented method comprising:
receiving an image of a prescription product to be dispensed according to a prescription to a patient;
processing the image with an artificial intelligence model to generate a condition signal indicating a prescription product condition;
sending the condition signal to an image analysis engine; and
responsive to receiving the condition signal, performing an action based on the prescription product condition.

2. The computer-implemented method of claim 1, wherein the image comprises a pill counting tray, and the prescription product is one or more pills.

3. The computer-implemented method of claim 1, wherein the prescription product condition is a number of pills in the image, and the condition signal comprises a numerical value of a pill count.

4. The computer-implemented method of claim 1, wherein the prescription product condition is one from a group of: image quality, image brightness, image blur, image focus, number of pills, types of pills in the image, co-mingling of two or more different pill types in the image, a broken pill, pill residue, non-pill object presence, strip presence, pill bottle presence, stacked pills, watermark, tamper condition, pill cut, and therapeutic classification.

5. The computer-implemented method of claim 1, wherein the artificial intelligence model is one from a group of: a neural network, a convolutional neural network, a random forest algorithm, a classifier, a You Only Look Once model, geometric systems, nearest neighbors and support vector machines, probabilistic systems, evolutionary systems, genetic algorithms, decision trees, Bayesian inference, boosting, logistic regression, faceted navigation, query refinement, query expansion, singular value decomposition, and a Markov chain.

6. The computer-implemented method of claim 1, wherein processing the image with the artificial intelligence model to generate the condition signal indicating the prescription product condition comprises:
processing the image with a first artificial intelligence model to generate a first condition signal indicating a first prescription product condition;
processing the image with a second artificial intelligence model to generate a second condition signal indicating a second prescription product condition; and
generating the prescription product condition based on a combination of the first prescription product condition and the second prescription product condition; and
wherein the first prescription product condition is different from the second prescription product condition.

7. The computer-implemented method of claim 1, further comprising generating an image annotation, wherein generating the image annotation comprises:
retrieving the image;
determining a portion of the received image to annotate;
generating an annotation based upon the prescription product condition;
combining the annotation with the received image to produce an annotated image; and
providing the annotated image for presentation to a user.

8. The computer-implemented method of claim 1, further comprising:
performing optical character recognition on the image to generate recognized text;
sending the recognized text to the image analysis engine; and
wherein the action is determined in part based upon the recognized text.

9. The computer-implemented method of claim 1, further comprising:
generating retraining annotations by performing inference on the artificial intelligence model;
generating labels from the retraining annotations;
generating a training set of images and labels;
processing one or more images in the training set of images to correct one or more mislabeled items and generate corrected data and weights;
retraining the artificial intelligence model using the corrected data and weights to produce a retrained artificial intelligence model; and
using the retrained artificial intelligence model for the artificial intelligence model.

10. The computer-implemented method of claim 1, wherein the action is one from a group of:
generating and sending a warning signal;
generating and sending the warning signal including the prescription product condition;
generating and sending a signal including a number of pills detected in the image;
generating an annotated image and presenting the annotated image for display;
generating an indication that the image of the prescription product is unacceptable and sending a recapture signal to prompt capture of another image to replace the image;
generating the indication that the image of the prescription product is unacceptable and automatically recapturing another image to replace the image; and
storing a copy of the image.

11. A system comprising one or more processors and memory operably coupled with the one or more processors, wherein the memory stores instructions that, in response to execution of the instructions by one or more processors, cause the one or more processors to perform operations of:
receiving an image of a prescription product to be dispensed according to a prescription to a patient;
processing the image with an artificial intelligence model to generate a condition signal indicating a prescription product condition;
sending the condition signal to an image analysis engine; and
responsive to receiving the condition signal, performing an action based on the prescription product condition.

12. The system of claim 11, wherein the prescription product condition is a number of pills in the image, and the condition signal comprises a numerical value of a pill count.

13. The system of claim 11, wherein the prescription product condition is one from a group of: image quality, image brightness, image blur, image focus, number of pills, types of pills in the image, co-mingling of two or more different pill types in the image, a broken pill, pill residue, non-pill object presence, strip presence, pill bottle presence, stacked pills, watermark, tamper condition, pill cut, and therapeutic classification.

14. The system of claim 11, wherein the artificial intelligence model is one from a group of: a neural network, a convolutional neural network, a random forest algorithm, a classifier, a You Only Look Once model, geometric systems, nearest neighbors and support vector machines, probabilistic systems, evolutionary systems, genetic algorithms, decision trees, Bayesian inference, boosting, logistic regression, faceted navigation, query refinement, query expansion, singular value decomposition, and a Markov chain.

15. The system of claim 11, wherein processing the image with the artificial intelligence model to generate the condition signal indicating the prescription product condition further comprises operations of:
processing the image with a first artificial intelligence model to generate a first condition signal indicating a first prescription product condition;
processing the image with a second artificial intelligence model to generate a second condition signal indicating a second prescription product condition; and
generating the prescription product condition based on a combination of the first prescription product condition and the second prescription product condition; and
wherein the first prescription product condition is different from the second prescription product condition.

16. The system of claim 11, wherein the operations further comprise generating an image annotation, wherein generating the image annotation comprises:
retrieving the image;
determining a portion of the received image to annotate;
generating an annotation based upon the prescription product condition;
combining the annotation with the received image to produce an annotated image; and
providing the annotated image for presentation to a user.

17. The system of claim 11, wherein the operations further comprise:
performing optical character recognition on the image to generate recognized text;
sending the recognized text to the image analysis engine; and
wherein the action is determined in part based upon the recognized text.

18. The system of claim 11, wherein the operations further comprise:
generating retraining annotations by performing inference on the artificial intelligence model;
generating labels from the retraining annotations;
generating a training set of images and labels;
process one or more images in the training set of images to correct one or more mislabeled items and generate corrected data and weights;
retraining the artificial intelligence model using the corrected data and weights to produce a retrained artificial intelligence model; and
using the retrained artificial intelligence model for the artificial intelligence model.

19. The system of claim 11, wherein the action is one from a group of:
generating and sending a warning signal;
generating and sending the warning signal including the prescription product condition;
generating and sending a signal including a number of pills detected in the image;
generating an annotated image and presenting the annotated image for display;
generating an indication that the image of the prescription product is unacceptable and sending a signal to prompt capture of another image to replace the image;
generating the indication that the image of the prescription product is unacceptable and automatically recapturing another image to replace the image; and
storing a copy of the image.

20. The system of claim 11, wherein the image comprises a pill counting tray, and the prescription product is one or more pills.

21. A non-transitory computer readable storage medium storing computer instructions executable by one or more processors to perform a method for virtual verification of a prescription product, the method comprising:
receiving an image of the prescription product to be dispensed according to a prescription to a patient;
processing the image with an artificial intelligence model to generate a condition signal indicating a prescription product condition;
sending the condition signal to an image analysis engine; and
responsive to receiving the condition signal, performing an action based on the prescription product condition.
